(19) United States
(12) Patent Application Publication
(10) Pub. No.: US 2013/0195177 A1
(43) Pub. Date: Aug. 1, 2013

(54) METHOD AND DEVICE FOR THE TRANSFORMATION AND METHOD AND DEVICE FOR THE REVERSE TRANSFORMATION OF IMAGES

(71) Applicants: Yoon-mi Hong, Seoul (KR); Woo-jin Han, Suwon-si (KR); Tammy Lee, Seoul (KR); Min-su Cheon, Yongin-si (KR); Vadim Seregin, Suwon-si (KR)

(72) Inventors: Yoon-mi Hong, Seoul (KR); Woo-jin Han, Suwon-si (KR); Tammy Lee, Seoul (KR); Min-su Cheon, Yongin-si (KR); Vadim Seregin, Suwon-si (KR)

(73) Assignee: SAMSUNG ELECTRONICS CO., LTD., Suwon-si (KR)

(21) Appl. No.: 13/876,760

(22) PCT Filed: Sep. 28, 2011
(86) PCT No.: PCT/KR2011/007164

§ 371 Date: Mar. 28, 2013

Related U.S. Application Data
(60) Provisional application No. 61/387,112, filed on Sep. 28, 2010.

(51) Int. Cl. H04N 7/26

(52) U.S. Cl. CPC H04N 19/00812
USPC 375/240.2; 375/240.18

(57) ABSTRACT

An image transforming method, an image transforming apparatus, an image inverse-transforming method, and an image inverse-transforming apparatus are provided. The image transforming method includes the operations of selecting a predetermined frequency area for performing a frequency transformation with respect to an M×N (where M and N are positive integers) input block, acquiring a truncated transform matrix by selecting elements to be used for a generation of transformation coefficients which correspond to the selected frequency area from among elements of an M×N transform matrix, and generating the transformation coefficients which correspond to the selected frequency area by performing the frequency transformation by applying the truncated transform matrix to the M×N input block.

### CROSS-REFERENCE TO RELATED APPLICATIONS

This application is a national stage entry of International Patent Application No. PCT/KR2011/007164, filed on Sep. 28, 2011, and claims the benefit of U.S. Provisional Patent Application No. 61/387,112, filed on Sep. 28, 2010 in the U.S. Patent and Trademark Office, the disclosures of which are incorporated herein by reference in their entireties.

### TECHNICAL FIELD

One or more exemplary embodiments relate to image encoding and image decoding, and more particularly, to an image transforming method, an image transforming apparatus, an image inverse-transforming method, and an image inverse-transforming apparatus for reducing calculation complexity by processing only a low frequency band of a block.

### BACKGROUND

According to a current international video coding standard, such as H.264 or MPEG-4, a video signal is hierarchically divided into a sequence, a frame, a slice, a macroblock, and a block, wherein the block is a minimum processing unit. With respect to encoding, a prediction remaining error of the block is determined via intra-frame or inter-frame prediction, block transformation is performed such that energy is focused on a coefficient of a decimal, and image data is compressed and recorded as a coded bitstream via quantization, scanning, run-length coding, and entropy coding. With respect to decoding, processes are performed in the opposite order. First, a block transformation coefficient of entropy coding is extracted from a bitstream. Then, a prediction remaining error of a block is reconstructed via inverse-quantization and inverse-transformation, and prediction information is used to reconstruct video data of the block. In an encoding-decoding process, a transformation module is a base of video compression, and transformation performance of the transformation module directly affects the general performance of a codec.

Discrete cosine transform (DCT) has been employed in conjunction with an initial video coding standard, such as MPEG-1 or H.261. After DCT was introduced in 1974, DCT has been widely used in image and video coding fields. Transformation performance of DCT is excellent compared to all sub-optimal transforms because DCT removes a correlation of image elements in a transformation domain and prepares a base for highly-efficient image compression. However, because a DCT matrix is expressed using floating point numbers, many system resources are used due to massive floating point operations. Accordingly, a new DCT algorithm is required so as to improve transformation efficiency while performing transformation on a large-size block.

### TECHNICAL PROBLEM

One or more exemplary embodiments provide image transforming methods, image transforming apparatuses, image inverse-transforming methods, and image inverse-transforming apparatuses for producing transformation coefficients belonging to a low frequency band via a less number of operations.

### TECHNICAL SOLUTION

According to an exemplary embodiment, transformation coefficients belonging to a low frequency band are extracted by using a truncated transform matrix which may be obtained by truncating an existing transform matrix.

### ADVANTAGEOUS EFFECTS

According to one or more exemplary embodiments, transformation and inverse-transformation are performed on only a selected low frequency band, and thus, the number of operations required by the transformation and inverse-transformation may be reduced. According to one or more exemplary embodiments, transformation and inverse-transformation are performed via additions, subtractions, and a shift operation, and thus, the number of operations required by the transformation and inverse-transformation may be reduced.

### BRIEF DESCRIPTION OF THE DRAWINGS

FIG. 1 is a block diagram of an image encoding apparatus, according to an exemplary embodiment;

FIG. 2 is a block diagram of an image transforming apparatus, according to an exemplary embodiment;

FIG. 3 is a reference diagram which illustrates a process by which a truncated transform matrix acquisition unit included in the image transforming apparatus of FIG. 2 acquires a truncated transform matrix based on a frequency band selected by a frequency area selection unit included in the image transforming apparatus of FIG. 2, according to an exemplary embodiment;

FIG. 4 is a flow graph of 4-point, 8-point, 16-point, and 32-point discrete cosine transform (DCT) operations, according to an exemplary embodiment;

FIG. 5 is a flow graph of a 32-point DCT operation, according to another exemplary embodiment;

FIG. 6 is a reference diagram which illustrates an operation process relating to a butterfly structure which forms the 32-point DCT of FIG. 5;

FIG. 7 is a flowchart which illustrates an image transforming method, according to an exemplary embodiment;

FIG. 8 is a block diagram of an image decoding apparatus, according to an exemplary embodiment;

FIG. 9 is a block diagram of an image inverse-transforming apparatus, according to an exemplary embodiment;

FIG. 10 is a reference diagram which illustrates a process by which a truncated inverse-transform matrix acquisition unit included in the image inverse-transforming apparatus of FIG. 9 acquires a truncated inverse-transform matrix based on a frequency band of a received transform block, according to an exemplary embodiment;

FIG. 11 is a flowchart which illustrates an image inverse-transforming method, according to an exemplary embodiment; and

FIGS. 12A and 12B are reference diagrams which illustrate transformation coefficients of a frequency band which is to be selected, according to an exemplary embodiment.

### SUMMARY

According to an aspect of one or more exemplary embodiments, there is provided an image transforming method comprising: selecting a predetermined frequency area for performing a frequency transformation with respect to an M×N input block, wherein M and N are positive integers; acquiring a truncated transform matrix by selecting elements to be used for a generation of transformation coefficients which correspond to the selected frequency area from among elements of an M×N transform matrix; and generating the transformation coefficients which correspond to the selected frequency area by performing the frequency transformation by applying the truncated transform matrix to the M×N input block.

According to another aspect of one or more exemplary embodiments, there is provided an image transforming apparatus comprising: a frequency area selection unit which selects a predetermined frequency area to be used for performing a frequency transformation with respect to an M×N input block, wherein M and N are positive integers; a truncated transform matrix acquiring unit which acquires a truncated transform matrix by selecting elements to be used for a generation of transformation coefficients which correspond to the selected frequency area from among elements of an M×N transform matrix; and a frequency transformation unit which generates the transformation coefficients which correspond to the selected frequency area by performing the frequency transformation by applying the truncated transform matrix to the M×N input block.

According to another aspect of one or more exemplary embodiments, there is provided an image inverse-transforming method comprising: receiving transformation coefficients of a predetermined frequency band from among transformation coefficients of an M×N block, wherein M and N are positive integers; acquiring a truncated inverse-transform matrix by selecting elements to be used for performing an inverse transformation with respect to the transformation coefficients of the predetermined frequency band from among elements of an M×N inverse-transform matrix; and restoring the M×N block by performing the frequency inverse-transformation by applying the truncated inverse-transform matrix to the received transformation coefficients of the predetermined frequency band.

According to another aspect of one or more exemplary embodiments, there is provided an image inverse-transforming apparatus comprising: a truncated inverse-transform matrix acquisition unit which acquires a truncated inverse-transform matrix by selecting elements to be used for performing an inverse transformation with respect to transformation coefficients which correspond to a predetermined frequency band from among elements of an M×N inverse-transform matrix to be used for performing a frequency inverse-transformation with respect to an M×N block, wherein M and N are positive integers; and an inverse-transformation unit which restores the M×N block by performing the frequency inverse-transformation by applying the truncated inverse-transform matrix to the transformation coefficients which correspond to the predetermined frequency band.

### DETAILED DESCRIPTION

Hereinafter, exemplary embodiments will be described more fully with reference to the accompanying drawings.

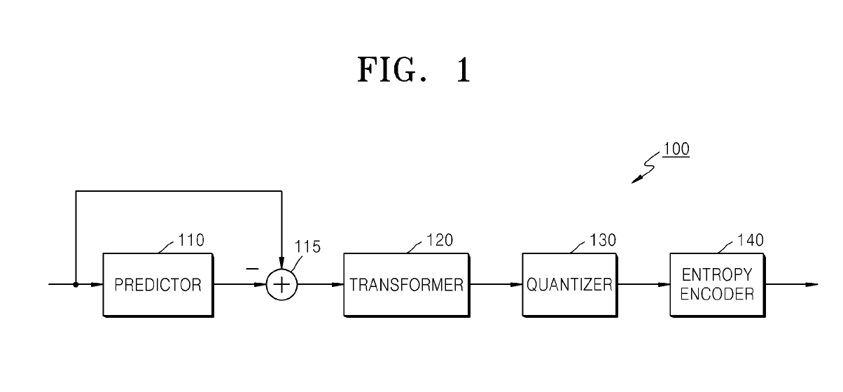

FIG. 1 is a block diagram of an image encoding apparatus 100, according to an exemplary embodiment.

Referring to FIG. 1, the image encoding apparatus 100 includes a predictor 110, a subtracter 115, a transformer 120, a quantizer 130, and an entropy encoder 140.

The predictor 110 divides an input image into blocks, each of which has a respective predetermined size, and generates a prediction block by performing inter prediction or intra prediction on each block. In detail, the predictor 110 performs inter prediction for generating a prediction block by using at least one of a motion prediction process and a compensation process, which processes generate a motion vector which indicates a region which is similar to a current block within a predetermined search range of a reference picture that has previously been encoded and then restored, and intra prediction for generating a prediction block by using data of an adjacent block that is adjacent to a current block.

The subtracter 115 generates a residual by subtracting the prediction block of the current block from original image data.

The transformer 120 transforms the residual to a frequency domain. Specifically, in exemplary embodiments, a discrete cosine transform (DCT) matrix which is defined with respect to an existing block having a relatively small size, such as a 4×4 block or an 8×8 block, may be enlarged and may be applied to a block having a size of at least 16×16. As is described below, the transformer 120 performs a DCT according to additions and subtractions based on an integer and a shift operation, instead of using a floating point operation, by substituting elements of a transformation matrix which is used for an existing DCT with rational numbers, thereby reducing a calculation complexity while increasing an operation speed. The transformer 120 may also perform a DCT by using a transformation matrix including elements that are obtained by multiplying the elements of a transformation matrix used for performing DCT by a power of 2 and then rounding up each of the multiplied elements to a respective nearest integer, thereby reducing overall calculation complexity. The transformer 120 obtains a truncated transform matrix by selecting elements for producing transformation coefficients which correspond to a predetermined frequency area from among the elements of an M×N transform matrix that is used for performing a frequency transformation with respect to an M×N input block, and performs a transformation by using the truncated transform matrix, thereby reducing the number of operations required for the transformation.

The quantizer 130 quantizes the transformed residual. The quantizer 130 may apply a predetermined scaling factor to a transformation value so as to reduce an error value as between a value transformed by using the transform matrix approximated by the transformer 120 and a value obtained via DCT based on an actual floating point operation.

The entropy encoder 140 generates a bitstream by performing variable length encoding on quantized image data.

Hereinafter, a process for performing image transformation according to an exemplary embodiment will be described more fully with reference to the accompanying drawings.

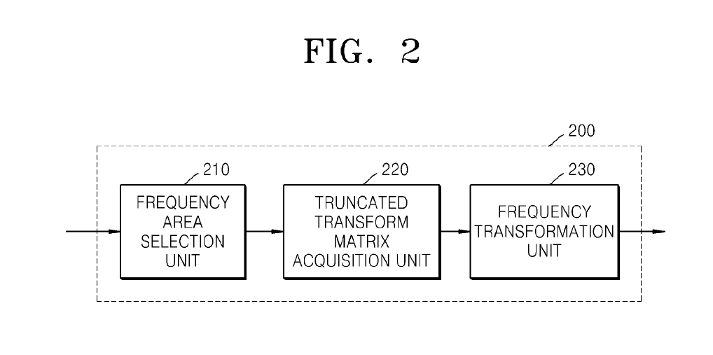

FIG. 2 is a block diagram of an image transforming apparatus 200 according to an exemplary embodiment. The image transforming apparatus 200 of FIG. 2 corresponds to the transformer 120 of FIG. 1.

Referring to FIG. 2, the image transforming apparatus 200 includes a frequency area selection unit 210, a truncated transform matrix acquisition unit 220, and a frequency transformation unit 230.

The frequency area selection unit 210 selects a predetermined frequency area for performing a frequency transformation with respect to an M×N (where M and N are positive integers) input block. In particular, when transforming the M×N input block into a frequency area, the frequency area selection unit 210 selects which frequency band of transformation coefficients is to be produced. Because generally a low frequency band of a transformed block which is produced via frequency transformation has a relatively high value, and generally a high frequency band has a relatively small value, the frequency area selection unit 210 may select a low frequency band in order to minimize an error while reducing the number of operations. The range of a low frequency band may be determined from a range which is pre-defined by an encoding side and a decoding side, or may be determined by analyzing the transformation coefficients of the transformed block and detecting a frequency band having non-zero transformation coefficients.

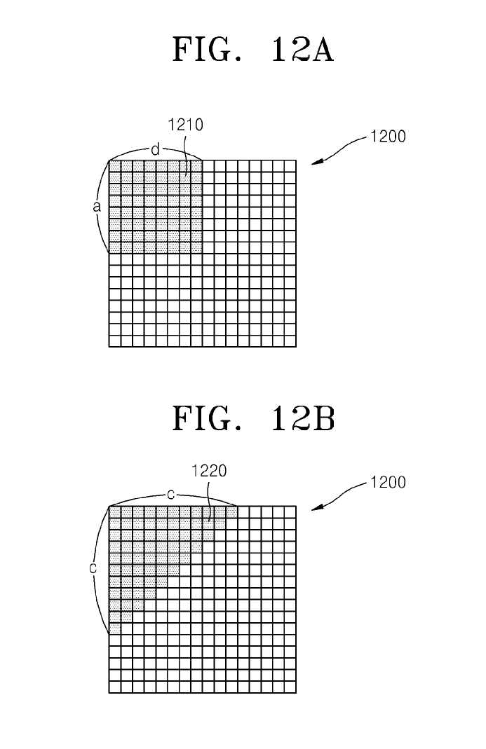

FIGS. 12A and 12B are reference diagrams which illustrate transformation coefficients of a frequency band which is to be selected, according to an exemplary embodiment.

Referring to FIGS. 12A and 12B, the frequency area selection unit 210 may determine which frequency band of transformation coefficients is to be acquired from an overall transformed block 1200. For example, in order to extract a low frequency band of transformation coefficients from the overall transformed block 1200, the frequency area selection unit 210 may select the transformation coefficients which correspond to an a×d transformed block 1210 as illustrated in FIG. 12A, or the transformation coefficients which correspond to a triangular block 1220 which surrounds the DC coefficient as illustrated in FIG. 12B. Information relating to the transformation coefficients in the selected frequency band, as in FIG. 12A, may be transmitted by including the values of a and d in a bitstream, or the values of a and d may be previously set based on the size information of the overall transformed block 1200 on at least one of the encoding side and the decoding side. When the triangular block 1220 is used as illustrated in FIG. 12B, information relating to the base c and the height c of the triangular block 1220 may be included in a bitstream, or the value of c may be previously set on at least one of the encoding side and the decoding side. Information regarding which type from among a rectangular block 1210, namely, the a×d transformed block 1210, and the triangular block 1220 of FIGS. 12A and 12B is used to define a low frequency band of which transformation coefficients are to be acquired may also be included in the form of a predetermined syntax in a bitstream and be transmitted.

The truncated transform matrix acquisition unit 220 acquires a truncated transform matrix by selecting elements to be used for a generation of transformation coefficients which correspond to the selected frequency band from among the elements of the M×N transform matrix for use in the frequency transformation with respect to the M×N input block. Herein, the frequency transformation is assumed to be a DCT. Examples of the DCT may include DCT based on an integer and DCT based on a floating-point operation. In the DCT assumed herein, a one-dimensional (1D) transform matrix is generally used in a column direction and in a row direction of the M×N input block.

The frequency transformation unit 230 generates transformation coefficients which correspond to the selected frequency band by performing a frequency transformation by applying the truncated transform matrix to the M×N input block.

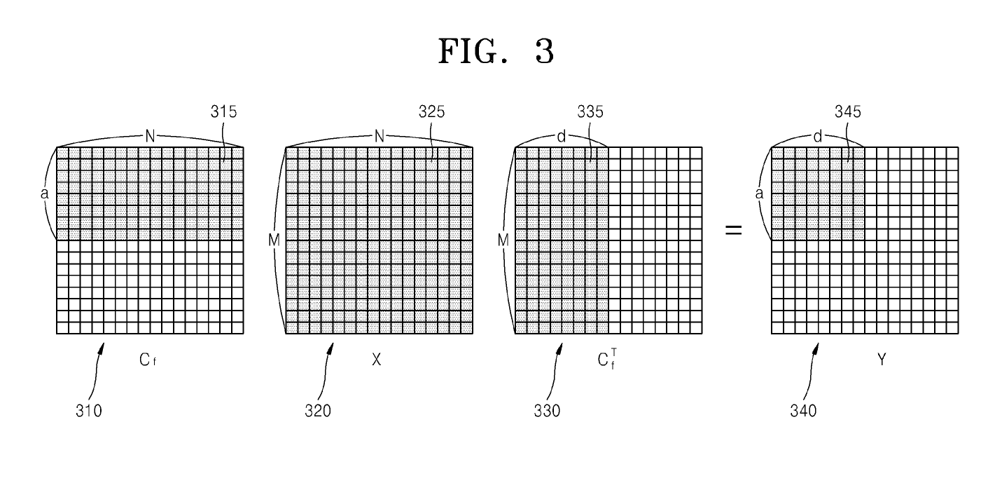

FIG. 3 is a reference diagram which illustrates a process by which the truncated transform matrix acquisition unit 220 acquires the truncated transform matrix based on the frequency band selected by the frequency area selection unit 210, according to an exemplary embodiment.

Referring to FIG. 3, when a matrix which represents the M×N input block is referred to as X 320, an M×N vertical transform matrix is referred to as Cf 310, and an M×N horizontal transform matrix is referred to as CfT 330, an M×N transformed block Y 340 may be obtained by transforming the M×N input block X 320 into a frequency area by performing a matrix operation which is expressible as Cf*X*CfT.

According to an exemplary embodiment, all of the transformation coefficients which constitute the M×N transformed block Y 340 are not acquired, but only the transformation coefficients in the frequency band selected by the frequency area selection unit 210 are acquired. As described above, when the M×N input block X 320 is transformed into a frequency area, the frequency area selection unit 210 may determine which frequency band of transformation coefficients are to be generated. As illustrated in FIG. 3, it is assumed that an a×d (where a denotes a positive integer which is smaller than M and d denotes a positive integer which is smaller than N) transformed block 345 which corresponds to a low frequency band is selected by the frequency area selection unit 210.

The a×d transformed block 345 in a low frequency band may be obtained by performing a matrix operation which is expressible as MCf*X*MCfT, by not applying the M×N vertical transform matrix Cf 310 and the M×N horizontal transform matrix CfT 330 but instead applying an a×N truncated vertical transform matrix MCf 315 and an M×d truncated horizontal transform matrix MCfT 335 which may be obtained by respectively truncating the M×N vertical transform matrix Cf 310 and the M×N horizontal transform matrix CfT 330. In order to acquire the a×d transformed block 345 in the low frequency band, the truncated transform matrix acquisition unit 220 produces the a×N truncated vertical transform matrix MCf 315 by selecting elements which correspond to the a uppermost rows from the M×N vertical transform matrix Cf 310. The truncated transform matrix acquisition unit 220 produces the M×d truncated horizontal transform matrix MCfT 335 by selecting elements which correspond to the d leftmost columns from the M×N horizontal transform matrix CfT 330. For example, as illustrated in FIG. 3, assuming M and N are each equal to 16 and a and d are each equal to 8, the truncated transform matrix acquisition unit 220 acquires an 8×16 truncated vertical transform matrix by selecting only the 8 uppermost rows from a 16×16 vertical transform matrix, and acquires a 16×8 truncated horizontal transform matrix by selecting only the leftmost 8 columns from a 16×16 horizontal transform matrix, thereby acquiring transformation coefficients which correspond to an 8×8 transformed block of a low frequency band. The frequency transformation unit 230 may produce the 8×8 transformed block by performing various matrix operations using one or more of the 8×16 truncated vertical transform matrix, the 16×8 truncated horizontal transform matrix, and the 16×16 input block. For example, an 8×16 intermediate value is produced by applying the 8×16 truncated vertical transform matrix to the 16×16 input block, and the 8×8 transformed block corresponding to the low frequency band is finally acquired by applying the 16×8 truncated horizontal transform matrix to the 8×16 intermediate value.

Further, when the value of an element located at a (i,k) (where i and k are integers) position of a vertical transform matrix is Aik, the (i,k)th element Aik of the vertical transform matrix for transformation of an N×N input block may be defined as shown below in Equation 1:

$${A}_{ik} = {α}_{i} cos \frac{π ( 2 k + 1 ) i}{2 N} \\ ( i , k = 0 , … , N - 1 , {α}_{0} = \sqrt{\frac{1}{N}} , {α}_{i} = \sqrt{\frac{2}{N}} ) \qquad [ Equation 1 ]$$

Because a horizontal transform matrix is the transpose of the corresponding vertical transform matrix, an (i,k)th element Bik of the horizontal transform matrix is expressed as a value obtained using a cosine function, similarly as with respect to the vertical transform matrix. In general, elements of such a transform matrix are not used in a transformation process, but products of the elements and a predetermined scaling coefficient may be used to perform a transformation process by using only additions and a shift operation. Although a floating point DCT is illustrated in Equation 1, a fixed point DCT may be used. When the product of an element of a transform matrix and a predetermined scaling coefficient is used during transformation, a de-scaling process of dividing a transformation coefficient by the predetermined scaling coefficient may be additionally performed during quantization.

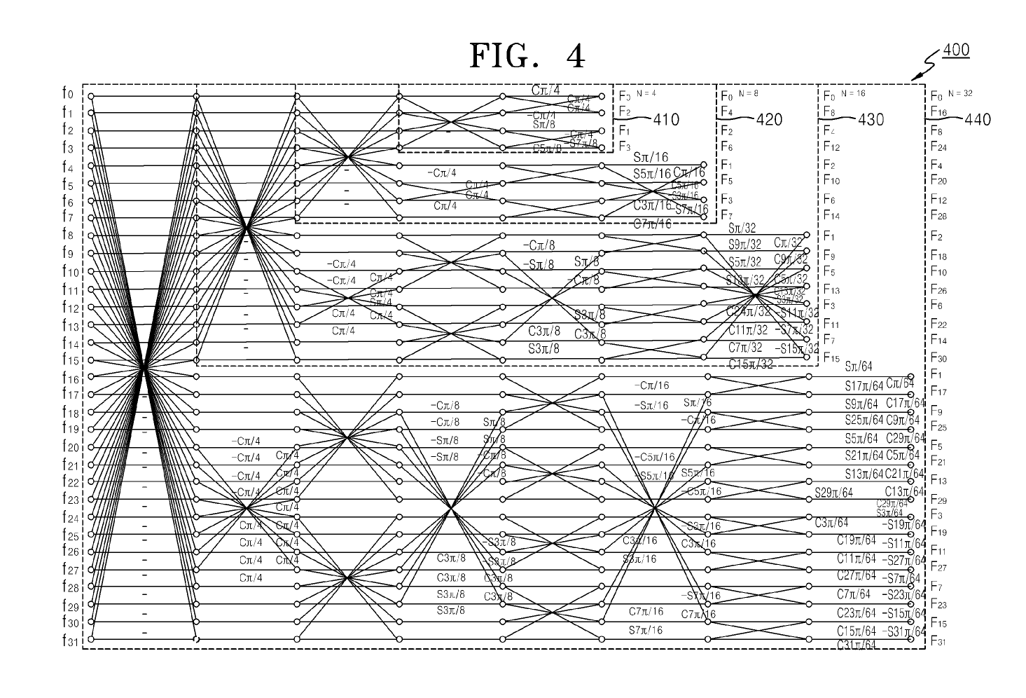

FIG. 4 is a flow graph 400 of 4-point, 8-point, 16-point, and 32-point DCT operations, according to an exemplary embodiment.

Referring to FIG. 4, f0 through f31 denote respective input values of one or more 1D transforms and, at the same time, denote respective output values of one or more 1D inverse transforms. A data processing direction during a transformation operation is from left to right, and a processing direction during an inverse transformation operation is from right to left. Two lines intersecting at a point denotes an addition of two numbers. A value above each line denotes a multiplication according to a corresponding coefficient. cθ denotes cos θ, sθ denotes sin θ, and a negative sign (i.e., “−”) denotes negation. A reference numeral 410 indicating a dashed line refers to a flow graph of a 4 point 1D DCT, a reference numeral 420 indicating a dashed line refers to a flow graph of an 8 point 1D DCT, a reference numeral 430 indicating a dashed line refers to a flow graph of a 16 point 1D DCT, and a reference numeral 440 indicating a dashed line refers to a flow graph of a 32 point 1D DCT.

As shown in the flow graph 400, cθ and sθ may become irrational numbers based on a corresponding value of θ in the DCT, and thus, calculation complexity may increase. Accordingly, even if an input value is an integer, a final transform result value may be mapped to an irrational number. Such a process of the DCT may increase complexity when realized using hardware. Accordingly, the method according to an exemplary embodiment provides an integer transforming method for substituting irrational numbers which are to be used for DCT with rational numbers such that a result from performing the DCT with the substitute rational numbers is approximately equal to a result value which would be obtained by performing the original DCT using the original irrational numbers. For example, a component cos(π×(i/2)/N) (where i denotes an integer which falls within a range of between 0 and N−1) of the elements constituting the N×N transform matrix may be substituted with N variables ai that are rational numbers. For example, when N=16, cos 0 may be substituted with a0, cos(π×(½)/16) may be substituted with a1, cos(π×(2/2)/16) may be substituted with a2, cos(π×(3/2)/16) may be substituted with a3, cos(π×(4/2)/16) may be substituted with a4, cos(π×(5/2)/16) may be substituted with a5, cos(π×(6/2)/16) may be substituted with a6, cos(π×(7/2)/16) may be substituted with a7, cos(π×(8/2)/16) may be substituted with a8, cos(π×(9/2)/16) may be substituted with a9, cos(π×(10/2)/16) may be substituted with a10, cos(π×(11/2)/16) may be substituted with a11, cos(π×(12/2)/16) may be substituted with a12, cos(π×(13/2)/16) may be substituted with a13, cos(π×(14/2)/16) may be substituted with a14, and cos(π×(15/2)/16) may be substituted with a15. The variables ai may be rational numbers, and a denominator of each variable ai may have a value of a power of 2, which is therefore capable of being subjected to a shift operation. The variable ai is limited to a dyadic rational, because if the denominator is a power of 2, a division operation may be performed by only using a right shift operation (>>). For example, when N is equal to 16, 16 variables ai may be equal to the following values; a1=63/64, a2=62/64, a3=61/64, a4=59/64, a5=56/64, a6=53/64, a7=49/64, a8=45/64, a9=40/64, a10=35/64, a11=30/64, a12=24/64, a13=18/64, a14=12/64, and a15=6/64. When N is equal to 32, 32 variables ai may be equal to the following values; a1=255/256, a2=254/256, a3=253/256, a4=251/256, a5=248/256, a6=244/256, a7=241/256, a8=236/256, a9=231/256, a10=225/256, a11=219/256, a12=212/256, a13=205/256, a14=197/256, a15=189/256, a16=181/256, a17=171/256, a18=162/256, a19=152/256, a20=142/256, a21=131/256, a22=120/256, a23=109/256, a24=97/256, a25=86/256, a26=74/256, a27=62/256, a28=49/256, a29=37/256, a30=25/256, and a31=12/256.

When M and N are each equal to 32, X0 through X31 denote input values, Ai, Bi, Ci, Di, Ei, Fi, and Gi (where i denotes an integer ranging from 0 to 31) denote intermediate values, and Y0 through Y31 denote output values, the frequency transformation unit 230 produces a 16×16 transformed block of a low frequency band by repeating the following point transformation with respect to row-direction input values and column-direction input values of a 32×32 input block based on the flow graph 400 of FIG. 4:

{

/stage 0

A0=X0+X31; A31=X0−X31; A1=X1+X30; A30=X1−X30; A2=X2+X29; A29=X2−X29; A3=X3+X28; A28=X3−X28; A4=X4+X27; A27=X4−X27; A5=X5+X26; A26=X5−X26; A6=X6+X25; A25=X6−X25; A7=X7+X24; A24=X7−X24; A8=X8+X23; A23=X8−X23; A9=X9+X22; A22=X9−X22; A10=X10+X21; A21=X10−X21; A11=X11+X20; A20=X11−X20; A12=X12+X19; A19=X12−X19; A13=X13+X18; A18=X13−X18; A14=X14+X17; A17=X14−X17; A15=X15+X16; A16=X15−X16;

/stage 1

B0=A0+A15; B15=A0−A15; B1=A1+A14; B14=A1−A14; B2=A2+A13; B13=A2−A13; B3=A3+A12; B12=A3−A12; B4=A4+A11; B11=A4−A11; B5=A5+A10; B10=A5−A10; B6=A6+A9; B9=A6−A9; B7=A7+A8; B8=A7−A8; B20=(181*(A27−A20))>>8; B27=(181*(A27+A20))>>8; B21=(181*(A26−A21))>>8; B26=(181*(A26+A21))>>8; B22=(181*(A25−A22))>>8; B25=(181*(A25+A22))>>8; B23=(181*(A24−A23))>>8; B24=(181*(A24+A23))>>8;

/Stage 2

C0=B0+B7; C7=B0−B7; C1=B1+B6; C6=B1−B6; C2=B2+B5; C5=B2−B5; C3=B3+B4; C4=B3−B4; C10=(181*(B13−B10))>>8; C13=(181*(B13+B10))>>8; C11=(181*(B12−B11))>>8; C12=(181*(B12+B11))>>8; C16=A16+B23; C23=A16−B23; C24=A31−B24; C31=A31+B24; C17=A17+B22; C22=A17−B22; C25=A30−B25; C30=A30+B25; C18=A18+B21; C21=A18−B21; C26=A29−B26; C29=A29+B26; C19=A19+B20; C20=A19−B20; C27=A28−B27; C28=A28+B27;

/stage 3

D0=C0+C3; D3=C0−C3; D8=B8+C11; D11=B8−C11; D12=B15−C12; D15=B15+C12; D1=C1+C2; D2=C1−C2; D9=B9+C10; D10=B9−C10; D13=B14−C13; D14=B14+C13; D5=(181*(C6−C5))>>8; D6=(181*(C6+C5))>>8; D18=(97*C29−236*C18)>>8; D20=(−236*C27−97*C20)>>8; D26=(−236*C21+97*C26)>>8; D28=(97*C19+236*C28)>>8; D19=(97*C28−236*C19)>>8; D21=(−236*C26−97*C21)>>8; D27=(−236*C20+97*C27)>>8; D29=(97*C18+236*C29)>>8;

/stage 4

Y0=(181*(D0+D1))>>8; Y8=(236*D3+97*D2)>>8;

E4=C4+D5; E5=C4−D5; E6=C7−D6; E7=C7+D6; E9=(97*D14−236*D9)>>8; E10=(−236*D13−97*D10)>>8; E13=(97*D13−236*D10)>>8; E14=(236*D14+97*D9)>>8; E16=C16+D19; E19=C16−D19; E20=C23−D20; E23=C23+D20; E24=C24+D27; E27=C24−D27; E28=C31−D28; E31=C31+D28; E17=C17+D18; E18=C17−D18; E21=C22−D21; E22=C22+D21; E25=C25+D26; E26=C25−D26; E29=C30−D29; E30=C30+D29;

/Stage 5

Y4=(49*E4+251*E7)>>8; Y12=(212*E6−142*E5)>>8; F8=D8+E9; F9=D8−E9; F10=D11−E10; F11=D11+E10; F12=D12+E13; F13=D12−E13; F14=D15−E14; F15=D15+E14; F17=(49*E30−251*E17)>>8; F18=(−251*E29−49*E18)>>8; F21=(212*E26−142*E21)>>8; F22=(−142*E25−212*E22)>>8; F25=(212*E25−142*E22)>>8; F26=(142*E26+212*E21)>>8; F29=(49*E29−251*E18)>>8; F30=(251*E30+49*E17)>>8;

/stage 6

Y2=(25*F8+254*F15)>>8; Y10=(120*F10+225*F13)>>8; Y6=(244*F12−74*F11)>>8; Y14=(197*F14−162*F9)>>8; G16=E16+F17; G17=E16−F17; G18=E19−F18; G19=E19+F18; G20=E20+F21; G21=E20−F21; G22=E23−F22; G23=E23+F22; G24=E24+F25; G25=E24−F25; G26=E27−F26; G27=E27+F26; G28=E28+F29; G29=E28−F29; G30=E31−F30; G31=E31+F30;

/stage 7

Y1=(12*G16+255*G31)>>8; Y9=(109*G18+231*G29)>>8; Y5=(62*G20+248*G27)>>8; Y13=(152*G22+205*G25)>>8; Y3=(253*G24−37*G23)>>8; Y11=(219*G26−131*G21)>>8; Y7=(241*G28−86*G19)>>8; Y15=(189*G30−171*G17)>>8; Y16=0; Y17=0; Y18=0; Y19=0; Y20=0; Y21=0; Y22=0; Y23=0; Y24=0; Y25=0; Y26=0; Y27=0; Y28=0; Y29=0; Y30=0; Y31=0;

}

For example, the frequency transformation unit 230 produces a 16×32 intermediate value matrix by repeating the above-described point transformation 32 times by applying each of the 32 columns of the 32×32 input block as the input values X0 through X31, and acquires a 16×16 transform matrix by repeating the above-described point transformation 16 times by applying 16 rows which constitute the 16×32 intermediate value matrix as the input values X0 through X31. The 16×16 transform matrix corresponds to the 16×16 transformed block of the low frequency band in a 32×32 transform matrix.

When M and N are each equal to 64, X0 through X63 denote input values, Ai, Bi, Ci, Di, Ei, Fi, Gi, Hi, and Zi (where i denotes an integer ranging from 0 to 63) denote intermediate values, and Y0 through Y63 denote output values, the frequency transformation unit 320 produces a 16×16 transformed block by repeating the following point transformation with respect to row-direction input values and column-direction input values of a 64×64 input block:

{

/stage 0

Z0=X0+X63; Z63=X0−X63; Z1=X1+X62; Z62=X1−X62; Z2=X2+X61; Z61=X2−X61; Z3=X3+X60; Z60=X3−X60; Z4=X4+X59; Z59=X4−X59; Z5=X5+X58; Z58=X5−X58; Z6=X6+X57; Z57=X6−X57; Z7=X7+X56; Z56=X7−X56; Z8=X8+X55; Z55=X8−X55; Z9=X9+X54; Z54=X9−X54; Z10=X10+X53; Z53=X10−X53; Z11=X11+X52; Z52=X11−X52; Z12=X12+X51; Z51=X12−X51; Z13=X13+X50; Z50=X13−X50; Z14=X14+X49; Z49=X14−X49; Z15=X15+X48; Z48=X15−X48; Z16=X16+X47; Z47=X16−X47; Z17=X17+X46; Z46=X17−X46; Z18=X18+X45; Z45=X18−X45; Z19=X19+X44; Z44=X19−X44; Z20=X20+X43; Z43=X20−X43; Z21=X21+X42; Z42=X21−X42; Z22=X22+X41; Z41=X22−X41; Z23=X23+X40; Z40=X23−X40; Z24=X24+X39; Z39=X24−X39; Z25=X25+X38; Z38=X25−X38; Z26=X26+X37; Z37=X26−X37; Z27=X27+X36; Z36=X27−X36; Z28=X28+X35; Z35=X28−X35; Z29=X29+X34; Z34=X29−X34; Z30=X30+X33; Z33=X30−X33; Z31=X31+X32; Z32=X31−X32;

/stage 1

A0=Z0+Z31; A31=Z0−Z31; A1=Z1+Z30; A30=Z1−Z30; A2=Z2+Z29; A29=Z2−Z29; A3=Z3+Z28; A28=Z3−Z28; A4=Z4+Z27; A27=Z4−Z27; A5=Z5+Z26; A26=Z5−Z26; A6=Z6+Z25; A25=Z6−Z25; A7=Z7+Z24; A24=Z7−Z24; A8=Z8+Z23; A23=Z8−Z23; A9=Z9+Z22; A22=Z9−Z22; A10=Z10+Z21; A21=Z10−Z21; A11=Z11+Z20; A20=Z11−Z20; A12=Z12+Z19; A19=Z12−Z19; A13=Z13+Z18; A18=Z13−Z18; A14=Z14+Z17; A17=Z14−Z17; A15=Z15+Z16; A16=Z15−Z16; A40=(724*(Z55−Z40))>>10; A55=(724*(Z55+Z40))>>10; A41=(724*(Z54−Z41))>>10; A54=(724*(Z54+Z41))>>10; A42=(724*(Z53−Z42))>>10; A53=(724*(Z53+Z42))>>10; A43=(724*(Z52−Z43))>>10; A52=(724*(Z52+Z43))>>10; A44=(724*(Z51−Z44))>>10; A51=(724*(Z51+Z44))>>10; A45=(724*(Z50−Z45))>>10; A50=(724*(Z50+Z45))>>10; A46=(724*(Z49−Z46))>>10; A49=(724*(Z49+Z46))>>10; A47=(724*(Z48−Z47))>>10; A48=(724*(Z48+Z47))>>10;

/stage 2

B0=A0+A15; B15=A0−A15; B1=A1+A14; B14=A1−A14; B2=A2+A13; B13=A2−A13; B3=A3+A12; B12=A3−A12; B4=A4+A11; B11=A4−A11; B5=A5+A10; B10=A5−A10; B6=A6+A9; B9=A6−A9; B7=A7+A8; B8=A7−A8; B20=(724*(A27−A20))>>10; B27=(724*(A27+A20))>>10; B21=(724*(A26−A21))>>10; B26=(724*(A26+A21))>>10; B22=(724*(A25−A22))>>10; B25=(724*(A25+A22))>>10; B23=(724*(A24−A23))>>10; B24=(724*(A24+A23))>>10; B32=Z32+A47; B47=Z32−A47; B48=Z63−A48; B63=Z63+A48; B33=Z33+A46; B46=Z33−A46; B49=Z62−A49; B62=Z62+A49; B34=Z34+A45; B45=Z34−A45; B50=Z61−A50; B61=Z61+A50; B35=Z35+A44; B44=Z35−A44; B51=Z60−A51; B60=Z60+A51; B36=Z36+A43; B43=Z36−A43; B52=Z59−A52; B59=Z59+A52; B37=Z37+A42; B42=Z37−A42; B53=Z58−A53; B58=Z58+A53; B38=Z38+A41; B41=Z38−A41; B54=Z57−A54; B57=Z57+A54; B39=Z39+A40; B40=Z39−A40; B55=Z56−A55; B56=Z56+A55;

/stage 3

C0=B0+B7; C7=B0−B7; C1=B1+B6; C6=B1−B6; C2=B2+B5; C5=B2−B5; C3=B3+B4; C4=B3−B4; C10=(724*(B13−B10))>>10; C13=(724*(B13+B10))>>10; C11=(724*(B12−B11))>>10; C12=(724*(B12+B11))>>10; C16=A16+B23; C23=A16−B23; C24=A31−B24; C31=A31+B24; C17=A17+B22; C22=A17−B22; C25=A30−B25; C30=A30+B25; C18=A18+B21; C21=A18−B21; C26=A29−B26; C29=A29+B26; C19=A19+B20; C20=A19−B20; C27=A28−B27; C28=A28+B27; C36=(392*B59−946*B36)>>10; C40=(−946*B55−392*B40)>>10; C52=(−946*B43+392*B52)>>10; C56=(392*B39+946*B56)>>10; C37=(392*B58−946*B37)>>10; C41=(−946*B54−392*B41)>>10; C53=(−946*B42+392*B53)>>10; C57=(392*B38+946*B57)>>10; C38=(392*B57−946*B38)>>10; C42=(−946*B53−392*B42)>>10; C54=(−946*B41+392*B54)>>10; C58=(392*B37+946*B58)>>10; C39=(392*B56−946*B39)>>10; C43=(−946*B52−392*B43)>>10; C55=(−946*B40+392*B55)>>10; C59=(392*B36+946*B59)>>10;

/stage 4

D0=C0+C3; D3=C0−C3; D8=B8+C11; D11=B8−C11; D12=B15−C12; D15=B15+C12; D1=C1+C2; D2=C1−C2; D9=B9+C10; D10=B9−C10; D13=B14−C13; D14=B14+C13; D5=(724*(C6−C5))>>10; D6=(724*(C6+C5))>>10; D18=(392*C29−946*C18)>>10; D20=(−946*C27−392*C20)>>10; D26=(−946*C21+392*C26)>>10; D28=(392*C19+946*C28)>>10; D19=(392*C28−946*C19)>>10; D21=(−946*C26−392*C21)>>10; D27=(−946*C20+392*C27)>>10; D29=(392*C18+946*C29)>>10; D32=B32+C39; D39=B32−C39; D40=B47−C40; D47=B47+C40; D48=B48+C55; D55=B48−C55; D56=B63−C56; D63=B63+C56; D33=B33+C38; D38=B33−C38; D41=B46−C41; D46=B46+C41; D49=B49+C54; D54=B49−C54; D57=B62−C57; D62=B62+C57; D34=B34+C37; D37=B34−C37; D42=B45−C42; D45=B45+C42; D50=B50+C53; D53=B50−C53; D58=B61−C58; D61=B61+C58; D35=B35+C36; D36=B35−C36; D43=B44−C43; D44=B44+C43; D51=B51+C52; D52=B51−C52; D59=B60−C59; D60=B60+C59;

/stage 5

Y0=(724*(D0+D1))>>10;

E4=C4+D5; E5=C4−D5; E6=C7−D6; E7=C7+D6; E9=(392*D14−946*D9)>>10; E10=(−946*D13−392*D10)>>10; E13=(392*D13−946*D10)>>10; E14=(946*D14+392*D9)>>10; D15=D15; E16=C16+D19; E19=C16−D19; E20=C23−D20; E23=C23+D20; E24=C24+D27; E27=C24−D27; E28=C31−D28; E31=C31+D28; E17=C17+D18; E18=C17−D18; E21=C22−D21; E22=C22+D21; E25=C25+D26; E26=C25−D26; E29=C30−D29; E30=C30+D29; E34=(200*D61−1004*D34)>>10; E35=(200*D60−1004*D35)>>10; E36=(−1004*D59−200*D36)>>10; E37=(−1004*D58−200*D37)>>10; E42=(851*D53−569*D42)>>10; E43=(851*D52−569*D43)>>10; E44=(−569*D51−851*D44)>>10; E45=(−569*D50−851*D45)>>10; E50=(851*D50−569*D45)>>10; E51=(851*D51−569*D44)>>10; E52=(569*D52+851*D43)>>10; E53=(569*D53+851*D42)>>10; E58=(200*D58−1004*D37)>>10; E59=(200*D59−1004*D36)>>10; E60=(1004*D60+200*D35)>>10; E61=(1004*D61+200*D34)>>10;

/stage 6

Y8=(200*E4+1004*E7)>>10;

F8=D8+E9; F9=D8−E9; F10=D11−E10; F11=D11+E10; F12=D12+E13; F13=D12−E13; F14=D15−E14; F15=D15+E14; F17=(200*E30−1004*E17)>>10; F18=(−1004*E29−200*E18)>>10; F21=(851*E26−569*E21)>>10; F22=(−569*E25−851*E22)>>10; F25=(851*E25−569*E22)>>10; F26=(569*E26+851*E21)>>10; F29=(200*E29−1004*E18)>>10; F30=(1004*E30+200*E17)>>10; F32=D32+E35; F33=D33+E34; F34=D33−E34; F35=D32−E35; F36=D39−E36; F37=D38−E37; F38=D38+E37; F39=D39+E36; F40=D40+E43; F41=D41+E42; F42=D41−E42; F43=D40−E43; F44=D47−E44; F45=D46−E45; F46=D46+E45; F47=D47+E44; F48=D48+E51; F49=D49+E50; F50=D49−E50; F51=D48−E51; F52=D55−E52; F53=D54−E53; F54=D54+E53; F55=D55+E52; F56=D56+E59; F57=D57+E58; F58=D57−E58; F59=D56−E59; F60=D63−E60; F61=D62−E61; F62=D62+E61; F63=D63+E60;

/stage 7

Y4=(100*F8+1019*F15)>>10; Y12=(980*F12−297*F11)>>10;

G16=E16+F17; G17=E16−F17; G18=E19−F18; G19=E19+F18; G20=E20+F21; G21=E20−F21; G22=E23−F22; G23=E23+F22; G24=E24+F25; G25=E24−F25; G26=E27−F26; G27=E27+F26; G28=E28+F29; G29=E28−F29; G30=E31−F30; G31=E31+F30; G33=(100*F62−1019*F33)>>10; G34=(−1019*F61−100*F34)>>10; G37=(792*F58−650*F37)>>10; G38=(−650*F57−792*F38)>>10; G41=(483*F54−903*F41)>>10; G42=(−903*F53−483*F42)>>10; G45=(980*F50−297*F45)>>10; G46=(−297*F49−980*F46)>>10; G49=(980*F49−297*F46)>>10; G50=(297*F50+980*F45)>>10; G53=(483*F53−903*F42)>>10; G54=(903*F54+483*F41)>>10; G57=(792*F57−650*F38)>>10; G58=(650*F58+792*F37)>>10; G61=(100*F61−1019*F34)>>10; G62=(1019*F62+100*F33)>>10;

/stage 8

Y2=(50*G16+1023*G31)>>10; Y10=(249*G20+993*G27)>>10; Y6=(1013*G24−150*G23)>>10; Y14=(964*G28−345*G19)>>10; H32=F32+G33; H33=F32−G33; H34=F35−G34; H35=F35+G34; H36=F36+G37; H37=F36−G37; H38=F39−G38; H39=F39+G38; H40=F40+G41; H41=F40−G41; H42=F43−G42; H43=F43+G42; H44=F44+G45; H45=F44−G45; H46=F47−G46; H47=F47+G46; H48=F48+G49; H49=F48−G49; H50=F51−G50; H51=F51+G50; H52=F52+G53; H53=F52−G53; H54=F55−G54; H55=F55+G54; H56=F56+G57; H57=F56−G57; H58=F59−G58; H59=F59+G58; H60=F60+G61; H61=F60−G61; H62=F63−G62; H63=F63+G62;

/stage 9

Y1=(25*H32+1024*H63)>>10; Y9=(224*H36+999*H59)>>10; Y5=(125*H40+1016*H55)>>10; Y13=(321*H44+972*H51)>>10; Y3=(1021*H48−75*H47)>>10; Y11=(987*H52−273*H43)>>10; Y7=(1009*H56−175*H39)>>10; Y15=(955*H60−369*H35)>>10; Y16=0; Y17=0; Y18=0; Y19=0; Y20=0; Y21=0; Y22=0; Y23=0; Y24=0; Y25=0; Y26=0; Y27=0; Y28=0; Y29=0; Y30=0; Y31=0; Y32=0; Y33=0; Y34=0; Y35=0; Y36=0; Y37=0; Y38=0; Y39=0; Y40=0; Y41=0; Y42=0; Y43=0; Y44=0; Y45=0; Y46=0; Y47=0; Y48=0; Y49=0; Y50=0; Y51=0; Y52=0; Y53=0; Y54=0; Y55=0; Y56=0; Y57=0; Y58=0; Y59=0; Y60=0; Y61=0; Y62=0; Y63=0;

}

For example, the frequency transformation unit 230 produces a 16×64 intermediate value matrix by repeating the above-described point transformation 64 times by applying each of the 64 columns of the 64×64 input block as the input values X0 through X63, and acquires a 16×16 transform matrix by repeating the above-described point transformation 16 times by applying 16 rows which constitute the 16×64 intermediate value matrix as the input values X0 through X63. The 16×16 transform matrix corresponds to the 16×16 transformed block of the low frequency band in a 64×64 transform matrix.

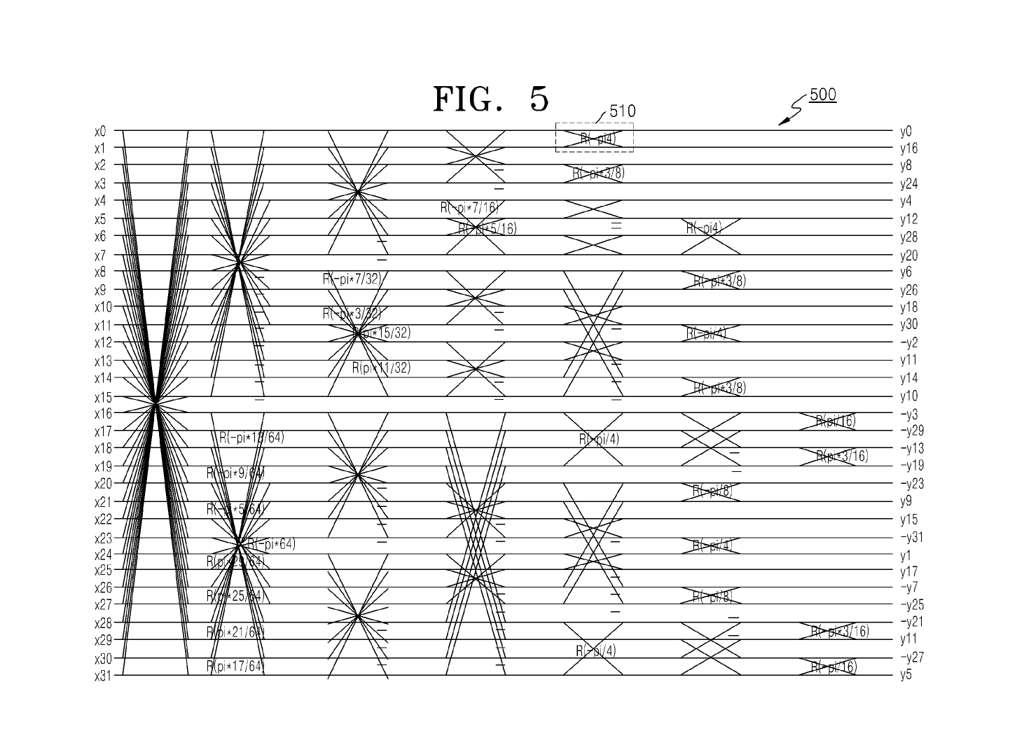

FIG. 5 is a flow graph 500 of a 32-point DCT operation, according to another exemplary embodiment.

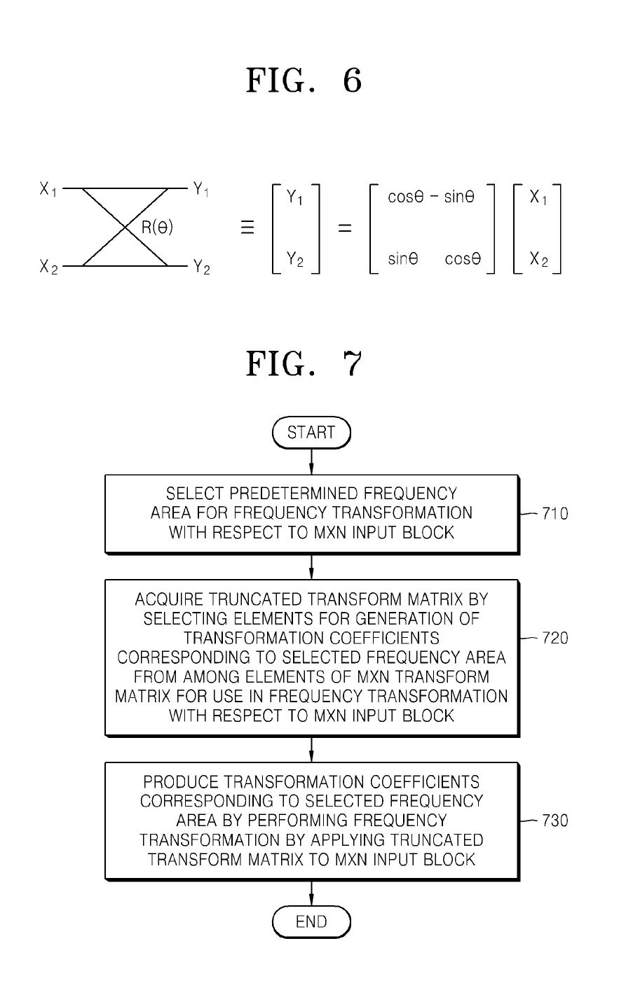

Referring to FIG. 5, x0 through x31 denote input values, and y0 through y31 denote output values of DCT. A data processing direction during transformation is from left to right, and a processing direction during inverse transformation is from right to left. Two lines intersecting at a point denotes an addition of two numbers, and a negative sign (i.e., “−”) denotes a negation. A value R(θ) above each line denotes an operation process which is based on a butterfly structure as shown in FIG. 6.

FIG. 6 is a reference diagram which illustrates an operation process relating to a butterfly structure which forms the 32-point DCT of FIG. 5.

Referring to FIG. 6, the operation process relating to the butterfly structure outputs an output value [Y1, Y2] via the equation

$$[ \begin{matrix}Y 1 \\ Y 2\end{matrix} ] = [ \begin{matrix}cos θ & - sin θ \\ sin θ & cos θ\end{matrix} ] [ \begin{matrix}X 1 \\ X 2\end{matrix} ] ,$$

with respect to an input value [X1,X2].

When a DCT is performed based on the flow graph 500 of FIG. 5, cos θ and sin θ are used according to the value R(θ). Similarly as described above with respect to the DCT which is performed by using the flow graph 400 of FIG. 4, operations required by DCT may be replaced with additions, subtractions, and a shift operation by using a dyadic rational as cos θ and sin θ based on a value of θ.

For example, when M and N are each equal to 32, X0 through X31 denote input values, Ai, Bi, Ci, Di, Ei, Fi, and Zi (where i denotes an integer ranging from 0 to 31) denote intermediate values, and Y0 through Y31 denote output values, the frequency transformation unit 230 produces a 16×16 transformed block of a low frequency band by repeating the following point transformation with respect to row-direction input values and column-direction input values of a 32×32 input block based on the algorithm of FIG. 5:

{

/stage 0

Z0=X0+X31; Z31=X0−X31; Z1=X1+X30; Z30=X1−X30; Z2=X2+X29; Z29=X2−X29; Z3=X3+X28; Z28=X3−X28; Z4=X4+X27; Z27=X4−X27; Z5=X5+X26; Z26=X5−X26; Z6=X6+X25; Z25=X6−X25; Z7=X7+X24; Z24=X7−X24; Z8=X8+X23; Z23=X8−X23; Z9=X9+X22; Z22=X9−X22; Z10=X10+X21; Z21=X10−X21; Z11=X11+X20; Z20=X11−X20; Z12=X12+X19; Z19=X12−X19; Z13=X13+X18; Z18=X13−X18; Z14=X14+X17; Z17=X14−X17; Z15=X15+X16; Z16=X15−X16;

/stage 1

A0=Z0+Z15; A1=Z1+Z14; A2=Z2+Z13; A3=Z3+Z12; A4=Z4+Z11; A5=Z5+Z10; A6=Z6+Z9; A7=Z7+Z8; A8=Z7−Z8; A9=Z6−Z9; A10=Z5−Z10; A11=Z4−Z11; A12=Z3−Z12; A13=Z2−Z13; A14=Z1−Z14; A15=Z0−Z15; A16=(171*Z16−189*Z31)>>8; A31=(189*Z16+171*Z31)>>8; A17=(205*Z17+152*Z30)>>8; A30=(−152*Z17+205*Z30)>>8; A18=(131*Z18−219*Z29)>>8; A29=(219*Z18+131*Z29)>>8; A19=(231*Z19+109*Z28)>>8; A28=(−109*Z19+231*Z28)>>8; A20=(86*Z20−241*Z27)>>8; A27=(241*Z20+86*Z27)>>8; A21=(248*Z21+62*Z26)>>8; A26=(−62*Z21+248*Z26)>>8; A22=(37*Z22−253*Z25)>>8; A25=(253*Z22+37*Z25)>>8; A23=(255*Z23+12*Z24)>>8; A24=(−12*Z23+255*Z24)>>8;

/stage 2

B0=A0+A7; B7=A0−A7; B1=A1+A6; B6=A1−A6; B2=A2+A5; B5=A2−A5; B3=A3+A4; B4=A3−A4; B8=(197*A8+162*A15)>>8; B15=(−162*A8+197*A15)>>8; B9=(120*A9−225*A14)>>8; B14=(225*A9+120*A14)>>8; B10=(244*A10+74*A13)>>8; B13=(−74*A10+244*A13)>>8; B11=(25*A11−254*A12)>>8; B12=(254*A11+25*A12)>>8; B16=A16+A23; B23=A16−A23; B17=A17+A22; B22=A17−A22; B18=A18+A21; B21=A18−A21; B19=A19+A20; B20=A19−A20; B24=A24+A31; B31=A24−A31; B25=A25+A30; B30=A25−A30; B26=A26+A29; B29=A26−A29; B27=A27+A28; B28=A27−A28;

/stage 3

C0=B0+B3; C3=B0−B3; C1=B1+B2; C2=B1−B2; C4=(49*B4+251*B7)>>8; C7=(−251*B4+49*B7)>>8; C5=(142*B5+212*B6)>>8; C6=(−212*B5+142*B6)>>8; C8=B8+B11; C11=B8−B11; C9=B9+B10; C10=B9−B10; C12=B12+B15; C15=B12−B15; C13=B13+B14; C14=B13−B14; C16=B16+B28; C28=B16−B28; C17=B17+B29; C29=B17−B29; C18=B18+B30; C30=B18−B30; C19=B19+B31; C31=B19−B31; C20=B20+B23; C23=B20−B23; C21=B21+B22; C22=B21−B22; C24=B24+B27; C27=B24−B27; C25=B25+B26; C26=B25−B26;

/stage 4

D0=(181*(C0+C1))>>8; D2=(97*C2+236*C3)>>8; D4=C4+C5; D5=C4−C5; D7=C6+C7; D8=C8+C14; D14=C8−C14; D9=C9+C15; D15=C9−C15; D11=C10−C11; D12=C12+C13; D13=C12−C13; D16=(181*(C16+C19))>>8; D19=(181*(−C16+C19))>>8; D20=C20+C26; D26=C20−C26; D21=C21+C27; D27=C21−C27; D22=C22+C23; D23=C22−C23; D24=C24+C25; D28=(181*(C28+C31))>>8; D31=(181*(−C28+C31))>>8;

/stage 5

E5=(181*(D5+D7))>>8; E8=(97*D8−236*D9)>>8; E12=(181*(−D11+D12))>>8; E15=(236*D14+97*D15)>>8; E16=D16+C18; E18=D16−C18; E17=C17+D19; E19=C17−D19; E21=(−97*D20+236*D21)>>8; E24=(181*(−D23+D24))>>8; E26=(236*D26+97*D27)>>8; E30=D28+C30; E29=−C29+D31; E31=C29+D31;

/stage 6

F16=(251*E16−49*E17)>>8; F18=(212*E18−142*E19)>>8; F28=(212*E28−142*E29)>>8; F29=(142*E28+212*E29)>>8; F31=(49*E30+251*E31)>>8;

/stage 7

Y0=D0; Y1=E24; Y2=E12; Y3=−F16; Y4=D4; Y5=F31; Y6=E8; Y7=−E26; Y8=D2; Y9=E21; Y10=E15; Y11=F29; Y12=E5; Y13=−F18; Y14=D13; Y15=D22; Y16=0; Y17=0; Y18=0; Y19=0; Y20=0; Y21=0; Y22=0; Y23=0; Y24=0; Y25=0; Y26=0; Y27=0; Y28=0; Y29=0; Y30=0; Y31=0;

}

For example, the frequency transformation unit 230 produces a 16×32 intermediate value matrix by repeating the above-described point transformation 32 times by applying each of the 64 columns of the 32×32 input block as the input values X0 through X31, and acquires a 16×16 transform matrix by repeating the above-described point transformation 16 times by applying 16 rows which constitute the 16×32 intermediate value matrix as the input values X0 through X31. The 16×16 transform matrix corresponds to the 16×16 transformed block of the low frequency band in a 64×64 transform matrix.

When M and N are each equal to 32, X0 through X31 denote input values, Ai, Bi, Ci, Di, Ei, Fi, and Zi (where i denotes an integer ranging from 0 to 31) denote intermediate values, and Y0 through Y31 denote output values, the frequency transformation unit 230 produces a transformed block by repeating the following point transformation with respect to row-direction input values and column-direction input values of a 32×32 input block based on the algorithm of FIG. 5:

{

/stage 0

Z0=X0+X31; Z31=X0−X31; Z1=X1+X30; Z30=X1−X30; Z2=X2+X29; Z29=X2−X29; Z3=X3+X28; Z28=X3−X28; Z4=X4+X27; Z27=X4−X27; Z5=X5+X26; Z26=X5−X26; Z6=X6+X25; Z25=X6−X25; Z7=X7+X24; Z24=X7−X24; Z8=X8+X23; Z23=X8−X23; Z9=X9+X22; Z22=X9−X22; Z10=X10+X21; Z21=X10−X21; Z11=X11+X20; Z20=X11−X20; Z12=X12+X19; Z19=X12−X19; Z13=X13+X18; Z18=X13−X18; Z14=X14+X17; Z17=X14−X17; Z15=X15+X16; Z16=X15−X16;

/stage 1

A0=Z0+Z15; A1=Z1+Z14; A2=Z2+Z13; A3=Z3+Z12; A4=Z4+Z11; A5=Z5+Z10; A6=Z6+Z9; A7=Z7+Z8; A8=Z7−Z8; A9=Z6−Z9; A10=Z5−Z10; A11=Z4−Z11; A12=Z3−Z12; A13=Z2−Z13; A14=Z1−Z14; A15=Z0−Z15;

A16=Z16−(113*Z31>>8); A31=Z31+(189*A16>>8); A16=A16−(113*A31>>8); A17=Z17+(84*Z30>>8); A30=Z30−(152*A17>>8); A17=A17+(84*A30>>8); A18=Z18−(145*Z29>>8); A29=Z29+(219*A18>>8); A18=A18−(145*A29>>8); A19=Z19+(57*Z28>>8); A28=Z28−(109*A19>>8); A19=A19+(57*A28>>8); A20=Z20−(180*Z27>>8); A27=Z27+(241*A20>>8); A20=A20−(180*A27>>8); A21=Z21+(31*Z26>>8); A26=Z26−(62*A21>>8); A21=A21+(31*A26>>8); A22=Z22−(220*Z25>>8); A25=Z25+(253*A22>>8); A22=A22−(220*A25>>8); A23=Z23+(6*Z24>>8); A24=Z24−(12*A23>>8); A23=A23+(6*A24>>8);

/stage 2

B0=A0+A7; B7=A0−A7; B1=A1+A6; B6=A1−A6; B2=A2+A5; B5=A2−A5; B3=A3+A4; B4=A3−A4;

B8=A8+(91*A15>>8); B15=A15−(162*B8>>8); B8=B8+(91*B15>>8); B9=A9−(153*A14>>8); B14=A14+(225*B9>>8); B9=B9−(153*B14>>8); B10=A10+(37*A13>>8); B13=A13−(74*B10>>8); B10=B10+(37*B13>>8); B11=A11−(232*A12>>8); B12=A12+(254*B11>>8); B11=B11−(232*B12>>8);

B16=A16+A23; B23=A16−A23; B17=A17+A22; B22=A17−A22; B18=A18+A21; B21=A18−A21; B19=A19+A20; B20=A19−A20;

B24=A24+A31; B31=A24−A31; B25=A25+A30; B30=A25−A30; B26=A26+A29; B29=A26−A29; B27=A27+A28; B28=A27−A28;

/stage 3

C0=B0+B3; C3=B0−B3; C1=B1+B2; C2=B1−B2;

C4=B4+(210*B7>>8); C7=B7−(251*C4>>8); C4=C4+(210*C7>>8); C5=B5+(136*B6>>8); C6=B6−(212*C5>>8); C5=C5+(136*C6>>8);

C8=B8+B11; C11=B8−B11; C9=B9+B10; C10=B9−B10;

C12=B12+B15; C15=B12−B15; C13=B13+B14; C14=B13−B14;

C16=B16+B28; C28=B16−B28; C17=B17+B29; C29=B17−B29; C18=B18+B30; C30=B18−B30; C19=B19+B31; C31=B19−B31;

C20=B20+B23; C23=B20−B23; C21=B21+B22; C22=B21−B22;

C24=B24+B27; C27=B24−B27; C25=B25+B26; C26=B25−B26;

/stage 4

D0=C0+C1;

D3=C2−(106*C3>>8); D2=C3+(90*D3>>8);

D4=C4+C5; D5=C4−C5;

D7=C6+C7;

D8=C8+C14; D14=C8−C14; D9=C9+C15; D15=C9−C15;

D11=C10−C11; D12=C12+C13; D13=C12−C13;

D16=C16+(106*C19>>8); D19=C19−(181*D16>>8); D16=D16+(106*D19>>8); D20=C20+C26; D26=C20−C26; D21=C21+C27; D27=C21−C27; D22=C22+C23; D23=C22−C23; D24=C24+C25;

D28=C28+(106*C31>>8); D31=C31−(181*D28>>8); D28=D28+(106*D31>>8);

/stage 5

E5=D5+D7;

E9=D8+(106*D9>>8); E8=−(D9−(90*E9>>8));

E11=D11+D12; E12=D12−(E11>>1);

E15=D14+(106*D15>>8);

E16=D16+C18; E18=D16−C18; E17=C17+D19; E19=C17−D19;

E20=D20+(106*D21>>8); E21=D21−(90*E20>>8); E23=D23+D24; E24=D24−(E23>>1); E26=D26+(106*D27>>8);

E28=−D28+C30; E30=D28+C30; E29=−C29+D31; E31=C29+D31;

/stage 6

F16=E16−(50*E17>>8);

F18=E18−(171*E19>>8);

F28=E28−(171*E29>>8); F29=E29+(118*F28>>8); F30=E30−(50*E31>>8); F31=E31+(48*F30>>8);

/stage 7

Y0=D0; Y1=E24; Y2=E12; Y3=−F16; Y4=D4; Y5=F31; Y6=E8; Y7=−E26; Y8=D2; Y9=E21; Y10=E15; Y11=F29; Y12=E5; Y13=−F18; Y14=D13; Y15=D22; Y16=0; Y17=0; Y18=0; Y19=0; Y20=0; Y21=0; Y22=0; Y23=0; Y24=0; Y25=0; Y26=0; Y27=0; Y28=0; Y29=0; Y30=0; Y31=0;

}

For example, the frequency transformation unit 230 produces a 16×32 intermediate value matrix by repeating the above-described point transformation 32 times by applying each of the 32 columns of the 32×32 input block as the input values X0 through X31, and acquires a 16×16 transform matrix of a low frequency band by repeating the above-described point transformation 16 times by applying 16 rows which constitute the 16×32 intermediate value matrix as the input values X0 through X31.

FIG. 7 is a flowchart which illustrates an image transforming method, according to an exemplary embodiment.

Referring to FIG. 7, in operation 710, the frequency area selection unit 210 selects a predetermined frequency area for performing a frequency transformation with respect to an M×N (where M and N are positive integers) input block. As described above, energy of a transformed block which results from a frequency transformation may be accumulated into a low frequency band, and thus, the frequency area selection unit 210 may select a low frequency band.

In operation 720, the truncated transform matrix acquisition unit 220 acquires a truncated transform matrix by selecting elements for performing a generation of transformation coefficients which correspond to the selected frequency band from among the elements of an M×N transform matrix for use in the frequency transformation with respect to the M×N input block. For example, in order to acquire an a×d transformed block in the low frequency band, the truncated transform matrix acquisition unit 220 generates an a×N truncated vertical transform matrix by selecting elements which correspond to the a uppermost rows from an M×N vertical transform matrix, and generates an M×d truncated horizontal transform matrix by selecting elements which correspond to the d leftmost columns from an M×N horizontal transform matrix.

In operation 730, the frequency transformation unit 230 generates transformation coefficients which correspond to the selected frequency band by performing the frequency transformation by applying the truncated transform matrix to the M×N input block.

According to the above-described exemplary embodiments, because transformation coefficients which correspond to only a selected frequency band from an overall transformed block are generated in a transformation process, a significance map representing positions of effective transformation coefficients, namely, non-zero transformation coefficients, within a block is generated for only the selected frequency band. Although only a case in which the selected low frequency band has a block shape has been illustrated, the shape of the selected low frequency band is not limited thereto, and various shapes of low frequency bands, such as a triangular low frequency band which surrounds a DCT coefficient, as shown in FIG. 12B, may be selected. Information regarding the selected low frequency band may be signaled by using a predetermined syntax independently from a bitstream, or, when an encoding side and a decoding side previously set the only shape and the only range of a low frequency band from which transformation coefficients are to be generated, transformation and inverse-transformation may be performed on only the previously-set low frequency band without transmitting a special syntax.

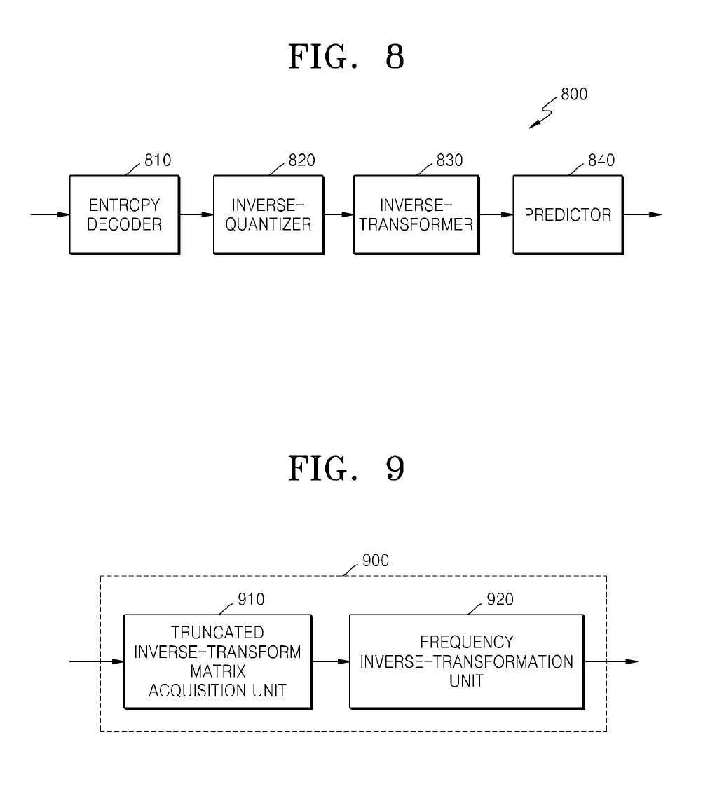

FIG. 8 is a block diagram of an image decoding apparatus 800, according to an exemplary embodiment.

Referring to FIG. 8, the image decoding apparatus 800 includes an entropy decoder 810, an inverse-quantizer 820, an inverse-transformer 830, and a predictor 840.

The entropy decoder 810 extracts prediction mode information, reference picture information, and residual information relating to a current block to be decoded, from an input bitstream.

The inverse-quantizer 820 inverse-quantizes quantized transformation coefficients, which have been entropy-decoded by the entropy decoder 810.

The inverse-transformer 830 inverse-transforms the inverse-quantized transformation coefficients. Accordingly, residual values for each block are restored. In particular, the inverse-transformer 830 performs an inverse DCT by executing additions and subtractions based on an integer and a shift operation, instead of a floating point operation, by substituting the elements of a transformation matrix which is used for an existing inverse DCT with rational numbers, thereby reducing calculation complexity while increasing an operation speed. The inverse-transformer 830 may also perform the inverse DCT by using an inverse transformation matrix which includes elements that are obtained by multiplying each of the elements of an inverse transformation matrix used for performing the inverse DCT by a power of 2 and then rounding up each of the multiplied elements to a respective nearest integer, thereby reducing overall calculation complexity. The inverse-transformer 830 also acquires a truncated inverse-transformation matrix by selecting elements for a generation of inverse-transformation coefficients which correspond to a predetermined frequency area from among the elements of an M×N inverse-transformation matrix for use in performing a frequency inverse-transformation with respect to an M×N input block, and performs the inverse-transformation by using the truncated inverse-transformation matrix, thereby reducing the number of operations required by the inverse-transformation.

The predictor 840 produces a prediction value relating to the current block via inter prediction or intra prediction, and restores the current block by adding the generated prediction value to the residual values which are restored by the inverse-transformer 830.

FIG. 9 is a block diagram of an image inverse-transforming apparatus 900, according to an exemplary embodiment. The image inverse-transforming apparatus 900 of FIG. 9 corresponds to the inverse-transformer 830 of FIG. 8.

Referring to FIG. 9, the image inverse-transforming apparatus 900 includes a truncated inverse-transform matrix acquisition unit 910 and a frequency inverse-transformation unit 920.

The truncated inverse-transform matrix acquisition unit 910 receives a transformed block of a predetermined frequency band and generates a truncated inverse-transform matrix for performing an inverse-transformation with respect to the received transformed block. For example, a bitstream may include information regarding various low frequency band shapes, such as, for example, a rectangular low frequency band block and a triangular low frequency band block, as shown in FIGS. 12A and 12B, and information regarding the sizes of a low frequency band, and the truncated inverse-transform matrix acquisition unit 910 may determine, based on the information regarding the low frequency band shapes and the information regarding the sizes of a low frequency band, to which shape and to which frequency band of transformation coefficients which have been acquired in the transformation correspond, from among the transformation coefficients included in an overall transformed block.

The truncated inverse-transform matrix acquisition unit 910 acquires a truncated inverse-transform matrix by selecting elements for performing the inverse-transformation with respect to the transformation coefficients which correspond to a frequency band of the received transformed block from among the elements of an M×N inverse-transform matrix for use in performing the frequency inverse-transformation with respect to an M×N (where M and N are positive integers) block. The M×N inverse-transform matrix corresponds to an inverse matrix of the M×N transform matrix and may be a substituted N×N inverse-transform matrix that is obtained by substituting the elements of an inverse-transform matrix which includes rational numbers, or may include elements which are obtained by multiplying each of the elements of the inverse-transform matrix by a power of 2 and then rounding up each of the multiplied elements to a respective nearest integer. When the substituted N×N transform matrix is used, an IDCT (inverse DCT) may be performed by using only additions, subtractions, and a shift operation.

The frequency inverse-transformation unit 920 produces a residual block by inversely transforming the M×N transformed block by applying the truncated inverse-transform matrix to the received transformed block of the predetermined frequency band.

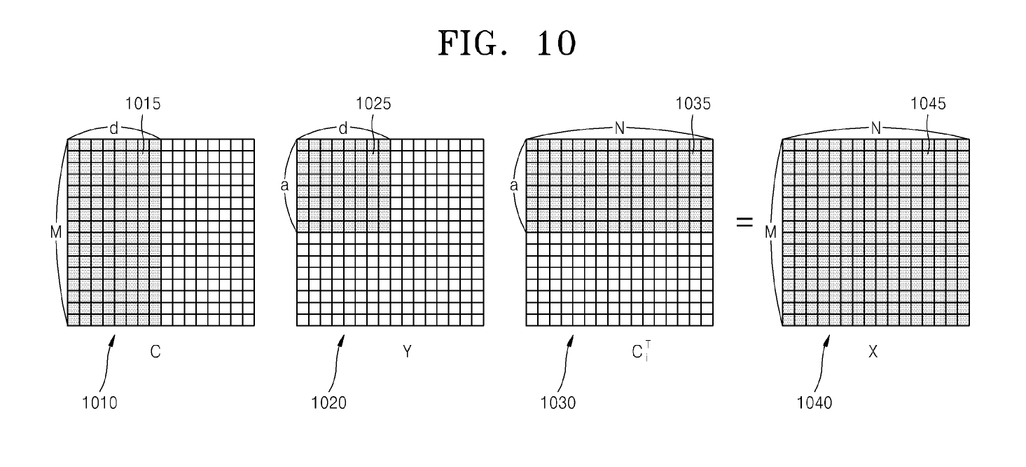

FIG. 10 is a reference diagram which illustrates a process by which the truncated inverse-transform matrix acquisition unit 910 acquires a truncated inverse-transform matrix based on the frequency band of the received transformed block, according to an exemplary embodiment.

Referring to FIG. 10, it is assumed that an a×d transformed block which is to be inversely transformed is Y 1025, an M×N vertical inverse-transform matrix is Ci 1010, and an M×N horizontal transform matrix is CiT 1030. The a×d transformed block Y 1025 includes only transformation coefficients which correspond to a low frequency band from among the transformation coefficients included in an M×N transformed block 1020, and may be inversely transformed by using the M×N vertical inverse-transform matrix Ci 1010 and the M×N horizontal inverse-transform matrix CiT 1030 without changes. Accordingly, the truncated inverse-transform matrix acquisition unit 910 restores an M×N residual block from the a×d transformed block Y 1025 of the low frequency band by performing a matrix operation which is expressible as MCi*Y*MCiT, by using an M×d truncated vertical inverse-transform matrix MCi 1015 and an a×N truncated horizontal transform matrix MCiT 1035 which may be obtained by respectively truncating each of the M×N vertical inverse-transform matrix Ci 1010 and the M×N horizontal inverse-transform matrix CiT 1030. For example, the truncated inverse-transform matrix acquisition unit 910 may generate the N×d truncated vertical transform matrix MCi 1015 by selecting elements which correspond to the d leftmost columns from the M×N vertical transform matrix Ci 1010. The truncated inverse-transform matrix acquisition unit 910 may generate the a×N truncated horizontal transform matrix MCiT 1035 by selecting elements which correspond to the a uppermost rows from the M×N horizontal transform matrix CiT 1030. For example, as illustrated in FIG. 10, assuming M and N are each equal to 16 and a and d are each equal to 8, the truncated inverse-transform matrix acquisition unit 910 acquires a 16×8 truncated vertical inverse-transform matrix by selecting only the 8 leftmost columns from a 16×16 vertical inverse-transform matrix and an 8×16 truncated horizontal inverse-transform matrix by selecting only the uppermost 8 rows from a 16×16 horizontal inverse-transform matrix, in order to restore a 16×16 residual block of a low frequency band by performing an inverse transformation with respect to an 8×8 transformed block of a low frequency band. The frequency inverse-transformation unit 920 may produce a 16×16 residual block by performing an inverse-transformation via matrix operations using the 16×8 truncated vertical inverse-transform matrix, the 8×16 truncated horizontal inverse-transform matrix, and the 8×8 transformed block. For example, a 16×8 intermediate value is produced by applying the 16×8 truncated vertical inverse-transform matrix to the 8×8 transformed block, and the 16×16 residual block is finally acquired by applying the 8×16 truncated horizontal inverse-transform matrix to the 16×8 intermediate value.

When M and N are each equal to 32, X0 through X15 denote input values, Ai, Bi, Ci, Di, Ei, Fi, and Gi (where i denotes an integer ranging from 0 to 31) denote intermediate values, and Y0 through Y31 denote output values, the frequency inverse-transformation unit 920 restores a 32×32 residual block by repeating the following point transformation with respect to the row-direction input values and the column-direction input values of the 16×16 transformed block of a low frequency band which is produced based on the flow graph 400 of FIG. 4:

{

/stage 0

G16=(12*X1)>>8; G17=(−171*X15)>>8; G18=(109*X9)>>8; G19=(−86*X7)>>8; G20=(62*X5)>>8; G21=(−131*X11)>>8; G22=(152*X13)>>8; G23=(−37*X3)>>8; G24=(253*X3)>>8; G25=(205*X13)>>8; G26=(219*X11)>>8; G27=(248*X5)>>8; G28=(241*X7)>>8; G29=(231*X9)>>8; G30=(189*X15)>>8; G31=(255*X1)>>8;

/Stage 1

F8=(25*X2)>>8; F9=(−162*X14)>>8; F10=(120*X10)>>8; F11=(−74*X6)>>8; F12=(244*X6)>>8; F13=(225*X10)>>8; F14=(197*X14)>>8; F15=(254*X2)>>8;

F16=G16+G17; F17=G16−G17; F18=G19−G18; F19=G19+G18; F20=G20+G21; F21=G20−G21; F22=G23−G22; F23=G23+G22; F24=G24+G25; F25=G24−G25; F26=G27−G26; F27=G27+G26; F28=G28+G29; F29=G28−G29; F30=G31−G30; F31=G31+G30;

/stage 2

E4=(49*X4)>>8; E5=(−142*X12)>>8; E6=(212*X12)>>8; E7=(251*X4)>>8;

E8=F8+F9; E9=F8−F9; E10=F11−F10; E11=F11+F10; E12=F12+F13; E13=F12−F13; E14=F15−F14; E15=F15+F14; E17=(49*F30−251*F17)>>8; E18=(−251*F29−49*F18)>>8; E21=(212*F26−142*F21)>>8; E22=(−142*F25−212*F22)>>8; E25=(212*F25−142*F22)>>8; E26=(142*F26+212*F21)>>8; E29=(49*F29−251*F18)>>8; E30=(251*F30+49*F17)>>8;

/stage 3

D0=(181*(X0))>>8; D1=(181*(X0))>>8; D2=(97*X8)>>8; D3=(236*X8)>>8;

D4=E4+E5; D5=E4−E5; D6=E7−E6; D7=E7+E6; D9=(97*E14−236*E9)>>8; D10=(−236*E13−97*E10)>>8; D13=(97*E13−236*E10)>>8; D14=(236*E14+97*E9)>>8; D16=F16+F19; D19=F16−F19; D20=F23−F20; D23=F23+F20; D24=F24+F27; D27=F24−F27; D28=F31−F28; D31=F31+F28; D17=E17+E18; D18=E17−E18; D21=E22−E21; D22=E22+E21; D25=E25+E26; D26=E25−E26; D29=E30−E29; D30=E30+E29;

/stage 4

C0=D0+D3; C3=D0−D3; C8=E8+E11; C11=E8−E11; C12=E15−E12; C15=E15+E12; C1=D1+D2; C2=D1−D2; C9=D9+D10; C10=D9−D10; C13=D14−D13; C14=D14+D13; C5=(181*(D6−D5))>>8; C6=(181*(D6+D5))>>8; C18=(97*D29−236*D18)>>8; C20=(−236*D27−97*D20)>>8; C26=(−236*D21+97*D26)>>8; C28=(97*D19+236*D28)>>8; C19=(97*D28−236*D19)>>8; C21=(−236*D26−97*D21)>>8; C27=(−236*D20+97*D27)>>8; C29=(97*D18+236*D29)>>8;

/stage 5

B0=C0+D7; B7=C0−D7; B1=C1+C6; B6=C1−C6; B2=C2+C5; B5=C2−C5; B3=C3+D4; B4=C3−D4; B10=(181*(C13−C10))>>8; B13=(181*(C13+C10))>>8; B11=(181*(C12−C11))>>8; B12=(181*(C12+C11))>>8; B16=D16+D23; B23=D16−D23; B24=D31−D24; B31=D31+D24; B17=D17+D22; B22=D17−D22; B25=D30−D25; B30=D30+D25; B18=C18+C21; B21=C18−C21; B26=C29−C26; B29=C29+C26; B19=C19+C20; B20=C19−C20; B27=C28−C27; B28=C28+C27;

/stage 6

A0=B0+C15; A15=B0−C15; A1=B1+C14; A14=B1−C14; A2=B2+B13; A13=B2−B13; A3=B3+B12; A12=B3−B12; A4=B4+B11; A11=B4−B11; A5=B5+B10; A10=B5−B10; A6=B6+C9; A9=B6−C9; A7=B7+C8; A8=B7−C8; A20=(181*(B27−B20))>>8; A27=(181*(B27+B20))>>8; A21=(181*(B26−B21))>>8; A26=(181*(B26+B21))>>8; A22=(181*(B25−B22))>>8; A25=(181*(B25+B22))>>8; A23=(181*(B24−B23))>>8; A24=(181*(B24+B23))>>8;

/stage 7

Y0=A0+B31; Y31=A0−B31; Y1=A1+B30; Y30=A1−B30; Y2=A2+B29; Y29=A2−B29; Y3=A3+B28; Y28=A3−B28; Y4=A4+A27; Y27=A4−A27; Y5=A5+A26; Y26=A5−A26; Y6=A6+A25; Y25=A6−A25; Y7=A7+A24; Y24=A7−A24; Y8=A8+A23; Y23=A8−A23; Y9=A9+A22; Y22=A9−A22; Y10=A10+A21; Y21=A10−A21; Y11=A11+A20; Y20=A11−A20; Y12=A12+B19; Y19=A12−B19; Y13=A13+B18; Y18=A13−B18; Y14=A14+B17; Y17=A14−B17; Y15=A15+B16; Y16=A15−B16;

}

When M and N are each equal to 64, X0 through X15 denote input values, Zi, Ai, Bi, Ci, Di, Ei, Fi, Gi, and Hi (where i denotes an integer ranging from 0 to 63) denote intermediate values, and Y0 through Y63 denote output values, the frequency inverse-transformation unit 920 restores a 64×64 residual block by repeating the following point transformation with respect to the row-direction input values and the column-direction input values of the 16×16 transformed block of a low frequency band which is produced based on the flow graph 400 of FIG. 4:

{

/stage 0

H32=(25*X1)>>10; H33=0; H34=0; H35=(−369*X15)>>10; H36=(224*X9)>>10; H37=0; H38=0; H39=(−175*X7)>>10; H40=(125*X5)>>10; H41=0; H42=0; H43=(−273*X11)>>10; H44=(321*X13)>>10; H45=0; H46=0; H47=(−75*X3)>>10; H48=(1021*X3)>>10; H49=0; H50=0; H51=(972*X13)>>10; H52=(987*X11)>>10; H53=0; H54=0; H55=(1016*X5)>>10; H56=(1009*X7)>>10; H57=0; H58=0; H59=(999*X9)>>10; H60=(955*X15)>>10; H61=0; H62=0; H63=(1024*X1)>>10;

/stage 1

G16=(50*X2)>>10; G17=0; G18=0; G19=(−345*X14)>>10; G20=(249*X10)>>10; G21=0; G22=0; G23=(−150*X6)>>10; G24=(1013*X6)>>10; G25=0; G26=0; G27=(993*X10)>>10; G28=(964*X14)>>10; G29=0; G30=0; G31=(1023*X2)>>10;

G32=H32+H33; G33=H32−H33; G34=H35−H34; G35=H35+H34; G36=H36+H37; G37=H36−H37; G38=H39−H38; G39=H39+H38; G40=H40+H41; G41=H40−H41; O42=H43−H42; G43=H43+H42; G44=H44+H45; G45=H44−H45; G46=H47−H46; G47=H47+H46; G48=H48+H49; G49=H48−H49; G50=H51−H50; G51=H51+H50; G52=H52+H53; G53=H52−H53; G54=H55−H54; G55=H55+H54; G56=H56+H57; G57=H56−H57; G58=H59−H58; G59=H59+H58; G60=H60+H61; G61=H60−H61; O62=H63−H62; G63=H63+H62;

/stage 2

F8=(100*X4)>>10; F9=0; F10=0; F11=(−297*X12)>>10; F12=(980*X12)>>10; F13=0; F14=0; F15=(1019*X4)>>10;

F16=G16+G17; F17=G16−G17; F18=G19−G18; F19=G19+G18; F20=G20+G21; F21=G20−G21; F22=G23−G22; F23=G23+G22; F24=G24+G25; F25=G24−G25; F26=G27−G26; F27=G27+G26; F28=G28+G29; F29=G28−G29; F30=G31−G30; F31=G31+G30; F33=(100*G62−1019*G33)>>10; F34=(−1019*G61−100*G34)>>10; F37=(792*G58−650*G37)>>10; F38=(−650*G57−792*G38)>>10; F41=(483*G54−903*G41)>>10; F42=(−903*G53−483*G42)>>10; F45=(980*G50−297*G45)>10; F46=(−297*G49−980*G46)>>10; F49=(980*G49−297*G46)>>10; F50=(297*G50+980*G45)>>10; F53=(483*G53−903*G42)>>10; F54=(903*G54+483*G41)>>10; F57=(792*G57−650*G38)>>10; F58=(650*G58+792*G37)>>10; F61=(100*G61−1019*G34)>>10; F62=(1019*G62+100*G33)>>10;

/stage 3

E4=(200*X8)>>10; E5=0; E6=0; E7=(1004*X8)>>10;

E8=F8+F9; E9=F8−F9; E10=F11−F10; E11=F11+F10; E12=F12+F13; E13=F12−F13; E14=F15−F14; E15=F15+F14; E17=(200*F30−1004*F17)>>10; E18=(−1004*F29−200*F18)>>10; E21=(851*F26−569*F21)>>10; E22=(−569*F25−851*F22)>>10; E25=(851*F25−569*F22)>>10; E26=(569*F26+851*F21)>>10; E29=(200*F29−1004*F18)>>10; E30=(1004*F30+200*F17)>>10; E32=G32+G35; E33=F33+F34; E34=F33−F34; E35=G32−G35; E36=G39−G36; E37=F38−F37; E38=F38+F37; E39=G39+G36; E40=G40+G43; E41=F41+F42; E42=F41−F42; E43=G40−G43; E44=G47−G44; E45=F46−F45; E46=F46+F45; E47=G47+G44; E48=G48+G51; E49=F49+F50; E50=F49−F50; E51=G48−G51; E52=G55−G52; E53=F54−F53; E54=F54+F53; E55=G55+G52; E56=G56+G59; E57=F57+F58; E58=F57−F58; E59=G56−G59; E60=G63−G60; E61=F62−F61; E62=F62+F61; E63=G63+G60;

/stage 4

D0=(724*(X0))>>10; D1=(724*(X0))>>10; D2=0; D3=0;

D4=E4+E5; D5=E4−E5; D6=E7−E6; D7=E7+E6; D9=(392*E14−946*E9)>>10; D10=(−946*E13−392*E10)>>10; D13=(392*E13−946*E10)>>10; D14=(946*E14+392*E9)>>10; D16=F16+F19; D19=F16−F19; D20=F23−F20; D23=F23+F20; D24=F24+F27; D27=F24−F27; D28=F31−F28; D31=F31+F28; D17=E17+E18; D18=E17−E18; D21=E22−E21; D22=E22+E21; D25=E25+E26; D26=E25−E26; D29=E30−E29; D30=E30+E29; D34=(200*E61−1004*E34)>>10; D35=(200*E60−1004*E35)>>10; D36=(−1004*E59−200*E36)>>10; D37=(−1004*E58−200*E37)>>10; D42=(851*E53−569*E42)>>10; D43=(851*E52−569*E43)>>10; D44=(−569*E51−851*E44)>>10; D45=(−569*E50−851*E45)>>10; D50=(851*E50−569*E45)>>10; D51=(851*E51−569*E44)>>10; D52=(569*E52+851*E43)>>10; D53=(569*E53+851*E42)>>10; D58=(200*E58−1004*E37)>>10; D59=(200*E59−1004*E36)>>10; D60=(1004*E60+200*E35)>>10; D61=(1004*E61+200*E34)>>10;

/stage 5

C0=D0+D3; C3=D0−D3; C8=E8+E11; C11=E8−E11; C12=E15−E12; C15=E15+E12; C1=D1+D2; C2=D1−D2; C9=D9+D10; C10=D9−D10; C13=D14−D13; C14=D14+D13; C5=(724*(D6−D5))>>10; C6=(724*(D6+D5))>>10; C18=(392*D29−946*D18)>>10; C20=(−946*D27−392*D20)>>10; C26=(−946*D21+392*D26)>>10; C28=(392*D19+946*D28)>>10; C19=(392*D28−946*D19)>>10; C21=(−946*D26−392*D21)>>10; C27=(−946*D20+392*D27)>>10; C29=(392*D18+946*D29)>>10; C32=E32+E39; C39=E32−E39; C40=E47−E40; C47=E47+E40; C48=E48+E55; C55=E48−E55; C56=E63−E56; C63=E63+E56; C33=E33+E38; C38=E33−E38; C41=E46−E41; C46=E46+E41; C49=E49+E54; C54=E49−E54; C57=E62−E57; C62=E62+E57; C34=D34+D37; C37=D34−D37; C42=D45−D42; C45=D45+D42; C50=D50+D53; C53=D50−D53; C58=D61−D58; C61=D61+D58; C35=D35+D36; C36=D35−D36; C43=D44−D43; C44=D44+D43; C51=D51+D52; C52=D51−D52; C59=D60−D59; C60=D60+D59;

/stage 6

B0=C0+D7; B7=C0−D7; B1=C1+C6; B6=C1−C6; B2=C2+C5; B5=C2−C5; B3=C3+D4; B4=C3−D4; B10=(724*(C13−C10))>>10; B13=(724*(C13+C10))>>10; B11=(724*(C12−C11))>>10; B12=(724*(C12+C11))>>10; B16=D16+D23; B23=D16−D23; B24=D31−D24; B31=D31+D24; B17=D17+D22; B22=D17−D22; B25=D30−D25; B30=D30+D25; B18=C18+C21; B21=C18−C21; B26=C29−C26; B29=C29+C26; B19=C19+C20; B20=C19−C20; B27=C28−C27; B28=C28+C27; B36=(392*C59−946*C36)>>10; B40=(−946*C55−392*C40)>>10; B52=(−946*C43+392*C52)>>10; B56=(392*C39+946*C56)>>10; B37=(392*C58−946*C37)>>10; B41=(−946*C54−392*C41)>>10; B53=(−946*C42+392*C53)>>10; B57=(392*C38+946*C57)>>10; B38=(392*C57−946*C38)>>10; B42=(−946*C53−392*C42)>>10; B54=(−946*C41+392*C54)>>10; B58=(392*C37+946*C58)>>10; B39=(392*C56−946*C39)>>10; B43=(−946*C52−392*C43)>>10; B55=(−946*C40+392*C55)>>10; B59=(392*C36+946*C59)>>10;

/stage 7

A0=B0+C15; A15=B0−C15; A1=B1+C14; A14=B1−C14; A2=B2+B13; A13=B2−B13; A3=B3+B12; A12=B3−B12; A4=B4+B11; A11=B4−B11; A5=B5+B10; A10=B5−B10; A6=B6+C9; A9=B6−C9; A7=B7+C8; A8=B7−C8; A20=(724*(B27−B20))>>10; A27=(724*(B27+B20))>>10; A21=(724*(B26−B21))>>10; A26=(724*(B26+B21))>>10; A22=(724*(B25−B22))>>10; A25=(724*(B25+B22))>>10; A23=(724*(B24−B23))>>10; A24=(724*(B24+B23))>>10; A32=C32+C47; A47=C32−C47; A48=C63−C48; A63=C63+C48; A33=C33+C46; A46=C33−C46; A49=C62−C49; A62=C62+C49; A34=C34+C45; A45=C34−C45; A50=C61−G50; A61=C61+C50; A35=C35+C44; A44=C35−C44; A51=C60−G51; A60=C60+C51; A36=B36+B43; A43=B36−B43; A52=B59−B52; A59=B59+B52; A37=B37+B42; A42=B37−B42; A53=B58−B53; A58=B58+B53; A38=B38+B41; A41=B38−B41; A54=B57−B54; A57=B57+B54; A39=B39+B40; A40=B39−B40; A55=B56−B55; A56=B56+B55;

/stage 8

Z0=A0+B31; Z31=A0−B31; Z1=A1+B30; Z30=A1−B30; Z2=A2+B29; Z29=A2−B29; Z3=A3+B28; Z28=A3−B28; Z4=A4+A27; Z27=A4−A27; Z5=A5+A26; Z26=A5−A26; Z6=A6+A25; Z25=A6−A25; Z7=A7+A24; Z24=A7−A24; Z8=A8+A23; Z23=A8−A23; Z9=A9+A22; Z22=A9−A22; Z10=A10+A21; Z21=A10−A21; Z11=A11+A20; Z20=A11−A20; Z12=A12+B19; Z19=A12−B19; Z13=A13+B18; Z18=A13−B18; Z14=A14+B17; Z17=A14−B17; Z15=A15+B16; Z16=A15−B16; Z40=(724*(A55−A40))>>10; Z55=(724*(A55+A40))>>10; Z41=(724*(A54−A41))>>10; Z54=(724*(A54+A41))>>10; Z42=(724*(A53−A42))>>10; Z53=(724*(A53+A42))>>10; Z43=(724*(A52−A43))>>10; Z52=(724*(A52+A43))>>10; Z44=(724*(A51−A44))>>10; Z51=(724*(A51+A44))>>10; Z45=(724*(A50−A45))>>10; Z50=(724*(A50+A45))>>10; Z46=(724*(A49−A46))>>10; Z49=(724*(A49+A46))>>10; Z47=(724*(A48−A47))>>10; Z48=(724*(A48+A47))>>10;

/stage 9

Y0=Z0+A63; Y63=Z0−A63; Y1=Z1+A62; Y62=Z1−A62; Y2=Z2+A61; Y61=Z2−A61; Y3=Z3+A60; Y60=Z3−A60; Y4=Z4+A59; Y59=Z4−A59; Y5=Z5+A58; Y58=Z5−A58; Y6=Z6+A57; Y57=Z6−A57; Y7=Z7+A56; Y56=Z7−A56; Y8=Z8+Z55; Y55=Z8−Z55; Y9=Z9+Z54; Y54=Z9−Z54; Y10=Z10+Z53; Y53=Z10−Z53; Y11=Z11+Z52; Y52=Z11−Z52; Y12=Z12+Z51; Y51=Z12−Z51; Y13=Z13+Z50; Y50=Z13−Z50; Y14=Z14+Z49; Y49=Z14−Z49; Y15=Z15+Z48; Y48=Z15−Z48; Y16=Z16+Z47; Y47=Z16−Z47; Y17=Z17+Z46; Y46=Z17−Z46; Y18=Z18+Z45; Y45=Z18−Z45; Y19=Z19+Z44; Y44=Z19−Z44; Y20=Z20+Z43; Y43=Z20−Z43; Y21=Z21+Z42; Y42=Z21−Z42; Y22=Z22+Z41; Y41=Z22−Z41; Y23=Z23+Z40; Y40=Z23−Z40; Y24=Z24+A39; Y39=Z24−A39; Y25=Z25+A38; Y38=Z25−A38; Y26=Z26+A37; Y37=Z26−A37; Y27=Z27+A36; Y36=Z27−A36; Y28=Z28+A35; Y35=Z28−A35; Y29=Z29+A34; Y34=Z29−A34; Y30=Z30+A33; Y33=Z30−A33; Y31=Z31+A32; Y32=Z31−A32;

}

When M and N are each equal to 32, X0 through X15 denote input values, Zi, Ai, Bi, Ci, Di, Ei, and Fi (where i denotes an integer ranging from 0 to 31) denote intermediate values, and Y0 through Y31 denote output values, the frequency inverse-transformation unit 920 restores a 32×32 residual block by repeating the following point transformation with respect to the row-direction input values and the column-direction input values of the 16×16 transformed block of a low frequency band which is produced based on the flow graph 500 of FIG. 5:

{

/stage 0

D0=X0; E24=X1; E12=X2; F16=−X3; D4=X4; F31=X5; E8=X6; E26=−X7; D2=X8; E21=X9; E15=X10; F29=X11; E5=X12; F18=−X13; D13=X14; D22=X15;

/stage 1

E16=(251*F16)>>8; E17=(−49*F16)>>8; E18=(212*F18)>>8; E19=(−142*F18)>>8; E28=(142*F29)>>8; E29=(212*F29)>>8; E30=(49*F31)>>8; E31=(251*F31)>>8;

/stage 2

D5=(181*(E5))>>8; D7=(181*(E5))>>8; D8=(97*E8)>>8; D9=(−236*E8)>>8; D11=(181*(−E12))>>8; D12=(181*(E12))>>8; D14=(236*E15)>>8; D15=(97*E15)>>8; D16=E16+E18; C18=E16−E18; C17=E17+E19; D19=E17−E19; D20=(−97*E21)>>8; D21=(236*E21)>>8; D23=(181*(−E24))>>8; D24=(181*(E24))>>8; D26=(236*E26)>>8; D27=(97*E26)>>8; D28=−E28+E30; C30=E28+E30; C29=−E29+E31; D31=E29+E31;

/stage 3

C0=(181*D0)>>8; C1=(181*D0)>>8; C2=(97*D2)>>8; C3=(236*D2)>>8; C4=D4+D5; C5=D4−D5; C6=D7; C7=D7; C8=D8+D14; C14=D8−D14; C9=D9+D15; C15=D9−D15; C10=D11; C11=−D11; C12=D12+D13; C13=D12−D13; C16=(181*(D16−D19))>>8; C19=(181*(D16+D19))>>8; C20=D2030 D26; C26=D20−D26; C21=D21+D27; C27=D21−D27; C22=D22+D23; C23=D22−D23; C24=D24; C25=D24; C28=(181*(D28−D31))>>8; C31=(181*(D28+D31))>>8;

/stage 4

B0=C0+C3; B3=C0−C3; B1=C1+C2; B2=C1−C2; B4=(49*C4−251*C7)>>8; B7=(251*C4+49*C7)>>8; B5=(142*C5−212*C6)>>8; B6=(212*C5+142*C6)>>8; B8=C8+C11; B11=C8−C11; B9=C9+C10; B10=C9−C10; B12=C12+C15; B15=C12−C15; B13=C13+C14; B14=C13−C14; B16=C16+C28; B28=C16−C28; B17=C17+C29; B29=C17−C29; B18=C18+C30; B30=C18−C30; B19=C19+C31; B31=C19−C31; B20=C20+C23; B23=C20−C23; B21=C21+C22; B22=C21−C22; B24=C24+C27; B27=C24−C27; B25=C25+C26; B26=C25−C26;

/stage 5

A0=B0+B7; A7=B0−B7; A1=B1+B6; A6=B1−B6; A2=B2+B5; A5=B2−B5; A3=B3+B4; A4=B3−B4; A8=(197*B8−162*B15)>>8; A15=(162*B8+197*B15)>>8; A9=(120*B9+225*B14)>>8; A14=(−225*B9+120*B14)>>8; A10=(244*B10−74*B13)>>8; A13=(74*B10+244*B13)>>8; A11=(25*B11+254*B12)>>8; A12=(−254*B11+25*B12)>>8; A16=B16+B23; A23=B16−B23; A17=B17+B22; A22=B17−B22; A18=B18+B21; A21=B18−B21; A19=B19+B20; A20=B19−B20; A24=B24+B31; A31=B24−B31; A25=B25+B30; A30=B25−B30; A26=B26+B29; A29=B26−B29; A27=B27+B28; A28=B27−B28;

/stage 6

Z0=A0+A15; Z1=A1+A14; Z2=A2+A13; Z3=A3+A12; Z4=A4+A11; Z5=A5+A10; Z6=A6+A9; Z7=A7+A8; Z8=A7−A8; Z9=A6−A9; Z10=A5−A10; Z11=A4−A11; Z12=A3−A12; Z13=A2−A13; Z14=A1−A14; Z15=A0−A15; Z16=(171*A16+189*A31)>>8; Z31=(−189*A16+171*A31)>>8; Z17=(205*A17−152*A30)>>8; Z30=(152*A17+205*A30)>>8; Z18=(131*A18+219*A29)>>8; Z29=(−219*A18+131*A29)>>8; Z19=(231*A19−109*A28)>>8; Z28=(109*A19+231*A28)>>8; Z20=(86*A20+241*A27)>>8; Z27=(−241*A20+86*A27)>>8; Z21=(248*A21−62*A26)>>8; Z26=(62*A21+248*A26)>>8; Z22=(37*A22+253*A25)>>8; Z25=(−253*A22+37*A25)>>8; Z23=(255*A23−12*A24)>>8; Z24=(12*A23+255*A24)>>8

/stage 7

Y0=Z0+Z31; Y31=Z0−Z31; Y1=Z1+Z30; Y30=Z1−Z30; Y2=Z2+Z29; Y29=Z2−Z29; Y3=Z3+Z28; Y28=Z3−Z28; Y4=Z4+Z27; Y27=Z4−Z27; Y5=Z5+Z26; Y26=Z5−Z26; Y6=Z6+Z25; Y25=Z6−Z25; Y7=Z7+Z24; Y24=Z7−Z24; Y8=Z8+Z23; Y23=Z8−Z23; Y9=Z9+Z22; Y22=Z9−Z22; Y10=Z10+Z21; Y21=Z10−Z21; Y11=Z11+Z20; Y20=Z11−Z20; Y12=Z12+Z19; Y19=Z12−Z19; Y13=Z13+Z18; Y18=Z13−Z18; Y14=Z14+Z17; Y17=Z14−Z17; Y15=Z15+Z16; Y16=Z15−Z16;

}

When M and N are each equal to 32, X0 through X15 denote input values, Zi, Ai, Bi, Ci, Di, Ei, and Fi (where i denotes an integer ranging from 0 to 31) denote intermediate values, and Y0 through Y31 denote output values, the frequency inverse-transformation unit 920 restores a 32×32 residual block by repeating the following point transformation with respect to the row-direction input values and the column-direction input values of the 16×16 transformed block of a low frequency band which is produced based on the flow graph 500 of FIG. 5:

{

/stage 0

D0=X0; E24=X1; E12=X2; F16=−X3; D4=X4; F31=X5; E8=X6; E26=−X7; D2=X8; E21=X9; E15=X10; F29=X11; E5=X12; F18=−X13; D13=X14; D22=X15;

/stage 1

E17=−(48*F16>>8); E16=F16+(50*E17>>8); E19=−(118*F18>>8); E18=F18+(171*E19>>8);

E29=F29; E28=(171*E29>>8); E31=F31; E30=(50*E31>>8);

/stage 2

D7=(E5>>1); D5=E5−D7;

D9=−E8; D8=−(106*D9>>8);

D12=E12; D11=−D12;

D15=(90*E15>>8); D14=E15−(106*D15>>8);

D16=E16+E18; C18=E16−E18; C17=E17+E19; D19=E17−E19;

D21=E21; D20=−(106*D21>>8); D24=E24; D23=−D24; D27=(90*E26>>8); D26=E26−(106*D27>>8); D28=−E28+E30; C30=E28+E30; C29=−E29+E31; D31=E29+E31;

/stage 3

C1=D0>>1; C0=D0−C1;

C3=D2; C2=(106*C3>>8);

C4=D4+D5; C5=D4−D5; C6=D7; C7=D7;

C8=D8+D14; C14=D8−D14; C9=D9+D15; C15=D9−D15; C10=D11;

C11=−D11; C12=D12+D13; C13=D12−D13;

D16=D16−(106*D19>>8); C19=D19+(181*D16>>8); C16=D16−(106*C19>>8); C20=D20+D26; C26=D20−D26; C21=D21+D27; C27=D21−D27; C22=D22+D23; C23=D22−D23; C24=D24; C25=D24; D28=D28−(106*D31>>8); C31=D31+(181*D28>>8); C28=D28−(106*C31>>8);

/stage 4

B0=C0+C3; B3=C0−C3; B1=C1+C2; B2=C1−C2;

C4=C4−(210*C7>>8); B7=C7+(251*C4>>8); B4=C4−(210*B7>>8); C5=C5−(136*C6>>8); B6=C6+(212*C5>>8); B5=C5−(136*B6>>8);

B8=C8+C11; B11=C8−C11; B9=C9+C10; B10=C9−C10;

B12=C12+C15; B15=C12−C15; B13=C13+C14; B14=C13−C14;

B16=C16+C28; B28=C16−C28; B17=C17+C29; B29=C17−C29; B18=C18+C30; B30=C18−C30; B19=C19+C31; B31=C19−C31;

B20=C20+C23; B23=C20−C23; B21=C21+C22; B22=C21−C22;

B24=C24+C27; B27=C24−C27; B25=C25+C26; B26=C25−C26;

/stage 5

A0=B0+B7; A7=B0−B7; A1=B1+B6; A6=B1−B6; A2=B2+B5; A5=B2−B5; A3=B3+B4; A4=B3−B4;

B8=B8−(91*B15>>8); A15=B15+(162*B8>>8); A8=B8−(91*A15>>8); B9=B9+(153*B14>>8); A14=B14−(225*B9>>8); A9=B9+(153*A14>>8); B10=B10−(37*B13>>8); A13=B13+(74*B10>>8); A10=B10−(37*A13>>8); B11=B11+(232*B12>>8); A12=B12−(254*B11>>8); A11=B11+(232*A12>>8); A16=B16+B23; A23=B16−B23; A17=B17+B22; A22=B17−B22; A18=B18+B21; A21=B18−B21; A19=B19+B20; A20=B19−B20;

A24=B24+B31; A31=B24−B31; A25=B25+B30; A30=B25−B30; A26=B26+B29; A29=B26−B29; A27=B27+B28; A28=B27−B28;

/stage 6

Z0=A0+A15; Z1=A1+A14; Z2=A2+A13; Z3=A3+A12; Z4=A4+A11; Z5=A5+A10; Z6=A6+A9; Z7=A7+A8; Z8=A7−A8; Z9=A6−A9; Z10=A5−A10; Z11=A4−A11; Z12=A3−A12; Z13=A2−A13; Z14=A1−A14; Z15=A0−A15;

A16=A16+(113*A31>>8); Z31=A31−(189*A16>>8); Z16=A16+(113*Z31>>8); A17=A17−(84*A30>>8); Z30=A30+(152*A17>>8); Z17=A17−(84*Z30>>8); A18=A18+(145*A29>>8); Z29=A29−(219*A18>>8); Z18=A18+(145*Z29>>8); A19=A19−(57*A28>>8); Z28=A28+(109*A19>>8); Z19=A19−(57*Z28>>8); A20=A20+(180*A27>>8); Z27=A27−(241*A20>>8); Z20=A20+(180*Z27>>8); A21=A21−(31*A26>>8); Z26=A26+(62*A21>>8); Z21=A21−(31*Z26>>8); A22=A22+(220*A25>>8); Z25=A25−(253*A22>>8); Z22=A22+(220*Z25>>8); A23=A23−(6*A24>>8); Z24=A24+(12*A23>>8); Z23=A23−(6*Z24>>8);

/stage 7

Y0=Z0+Z31; Y31=Z0−Z31; Y1=Z1+Z30; Y30=Z1−Z30; Y2=Z2+Z29; Y29=Z2−Z29; Y3=Z3+Z28; Y28=Z3−Z28; Y4=Z4+Z27; Y27=Z4−Z27; Y5=Z5+Z26; Y26=Z5−Z26; Y6=Z6+Z25; Y25=Z6−Z25; Y7=Z7+Z24; Y24=Z7−Z24; Y8=Z8+Z23; Y23=Z8−Z23; Y9=Z9+Z22; Y22=Z9−Z22; Y10=Z10+Z21; Y21=Z10−Z21; Y11=Z11+Z20; Y20=Z11−Z20; Y12=Z12+Z19; Y19=Z12−Z19; Y13=Z13+Z18; Y18=Z13−Z18; Y14=Z14+Z17; Y17=Z14−Z17; Y15=Z15+Z16; Y16=Z15−Z16;

}

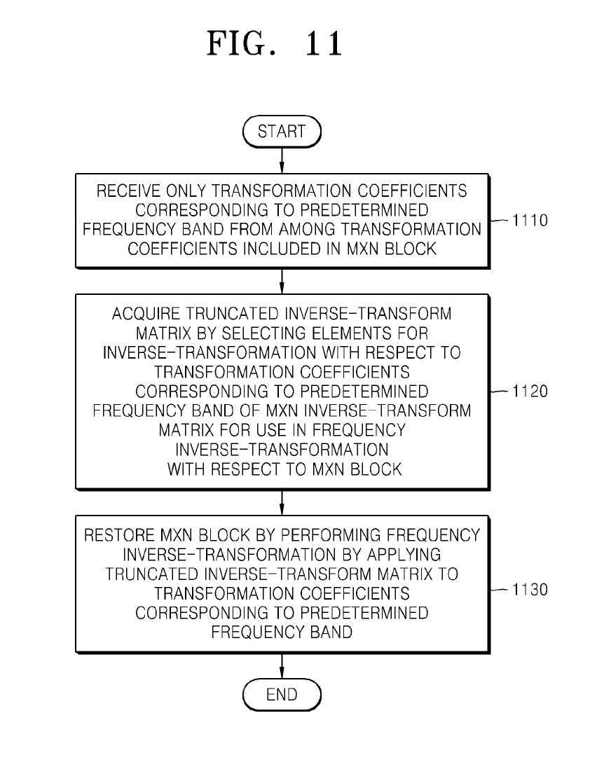

FIG. 11 is a flowchart which illustrates an image inverse-transforming method, according to an exemplary embodiment.

Referring to FIG. 11, in operation 1110, the truncated inverse-transform matrix acquisition unit 910 receives only transformation coefficients which correspond to a predetermined frequency band from among the transformation coefficients which are included in an M×N (where M and N are positive integers) block. In operation 1120, the truncated inverse-transform matrix acquisition unit 910 acquires a truncated inverse-transform matrix by selecting elements for performing an inverse-transformation with respect to the transformation coefficients which correspond to the predetermined frequency band of an M×N inverse-transform matrix for use in performing a frequency inverse-transformation with respect to the M×N block. As described above, a bitstream may include information regarding various low frequency band shapes, such as, for example, a rectangular low frequency band block and a triangular low frequency band block, as shown in FIGS. 12A and 12B, and information regarding the sizes of a low frequency band, and the truncated inverse-transform matrix acquisition unit 910 may determine, based on the information regarding the low frequency band shapes and the information regarding the sizes of a low frequency band, to which shape and to which frequency band of transformation coefficients the transformation coefficients acquired in transformation correspond, from among the transformation coefficients which are included in an overall transformed block.

When the size of a transformed block to be inversely transformed is a×d, the truncated inverse-transform matrix acquisition unit 910 produces an N×d truncated vertical inverse-transform matrix by selecting elements which correspond to the d leftmost columns from an M×N vertical inverse-transform matrix, and produces an a×N truncated horizontal inverse-transform matrix by selecting elements which correspond to the a uppermost rows from an M×N horizontal inverse-transform matrix.

In operation 1130, the frequency inverse-transformation unit 920 performs the frequency inverse-transformation by applying the truncated inverse-transform matrix to the transformation coefficients which correspond to the predetermined frequency band. In the above-described example, an M×N residual block is restored by performing matrix operations using the a×d transformed block, the N×d truncated vertical inverse-transform matrix, and the a×N truncated horizontal inverse-transform matrix.

One or more exemplary embodiments can also be embodied as computer-readable codes on a transitory or non-transitory computer-readable recording medium. The computer-readable recording medium may include any data storage device that can store data which can be thereafter read by a computer system. Examples of the non-transitory computer-readable recording medium include read-only memory (ROM), random-access memory (RAM), compact disk-ROMs (CD-ROMs), magnetic tapes, floppy disks, optical data storage devices, and/or any other suitable non-transitory medium. The computer-readable recording medium can also be distributed over network-coupled computer systems so that the computer-readable code is stored and executed in a distributed fashion. Moreover, one or more units of the above-described elements may include a processor or microprocessor which is configured to execute a computer program which is stored in a computer-readable medium.

While exemplary embodiments have been particularly shown and described above, it will be understood by those of ordinary skill in the art that various changes in form and details may be made therein without departing from the spirit and scope of the present inventive concept as defined by the following claims.

1. An image transforming method comprising:
selecting a predetermined frequency area for performing a frequency transformation with respect to an M×N input block, wherein M and N are positive integers;
acquiring a truncated transform matrix by selecting elements to be used for a generation of transformation coefficients which correspond to the selected frequency area from among elements of an M×N transform matrix; and
generating the transformation coefficients which correspond to the selected frequency area by performing the frequency transformation by applying the truncated transform matrix to the M×N input block.

2. The image transforming method of claim 1, wherein
the acquiring of the truncated transform matrix comprises: when an a×d low frequency area for the frequency transformation with respect to the M×N input block is selected, wherein a denotes a positive integer which is smaller than M and d denotes a positive integer which is smaller than N,
acquiring an a×N truncated vertical transform matrix from an M×N vertical transform matrix; and
acquiring an M×d truncated horizontal transform matrix from an M×N horizontal transform matrix.

3. The image transforming method of claim 2, wherein
the generating of the transformation coefficients comprises: when a matrix representing the M×N input block is expressible as X, the truncated vertical transform matrix is expressible as MCf, and the truncated horizontal transform matrix is expressible as MCfT, generating transformation coefficients which correspond to the a×d low frequency area by performing a matrix operation which is expressible as MCf*X*MCfT.

4. An image inverse-transforming method comprising:
receiving transformation coefficients of a predetermined frequency band from among transformation coefficients of an M×N block, wherein M and N are positive integers;
acquiring a truncated inverse-transform matrix by selecting elements to be used for performing an inverse transformation with respect to the transformation coefficients of the predetermined frequency band from among elements of an M×N inverse-transform matrix; and
restoring the M×N block by performing the frequency inverse-transformation by applying the truncated inverse-transform matrix to the received transformation coefficients of the predetermined frequency band.

5. The image inverse-transforming method of claim 4, wherein a shape of the predetermined frequency band includes at least one of a rectangle and a triangle.

6. The image inverse-transforming method of claim 5, further comprising extracting shape information relating to the predetermined frequency band and size information relating to the predetermined frequency band from a bitstream.

7. The image inverse-transforming method of claim 4, wherein
the acquiring the truncated inverse-transform matrix comprises: when the transformation coefficients of the predetermined frequency band include transformation coefficients of an a×d low frequency band which is positioned at a leftmost portion of the M×N block from among the transformation coefficients of the M×N block, wherein a denotes a positive integer which is smaller than M and d denotes a positive integer which is smaller than N,
acquiring an M×d truncated vertical inverse-transform matrix from an M×N vertical inverse-transform matrix; and
acquiring an a×N truncated horizontal inverse-transform matrix from an M×N horizontal inverse-transform matrix.

8. The image inverse-transforming method of claim 7, wherein the restoring the M×N block comprises: when a matrix representing the transformation coefficients of the a×d low frequency band is expressible as X, the truncated vertical inverse-transform matrix is expressible as MCi, and the truncated horizontal transform matrix is expressible as MCiT, restoring the M×N block by performing a matrix operation which is expressible as MCi*X*MCiT.

9. The image inverse-transforming method of claim 4, wherein the M×N inverse-transform matrix includes an inverse-transform matrix which is obtainable by substituting values based on a trigonometric function from among elements of an M×N inverse-transform matrix to be used for performing a one-dimensional (1D) inverse discrete cosine transform (IDCT) with rational numbers.

10. The image inverse-transforming method of claim 4, wherein the restoring the M×N block comprises performing at least one of a shift operation, additions, and subtractions with which multiplications included in a transformation process using the inverse-transform matrix are substituted.

11. The image inverse-transforming method of claim 10, wherein, when each of M and N is equal to 32, each of a and d is equal to 16, X0 through X15 denote input values to be inversely transformed, Ai, Bi, Ci, Di, Ei, Fi, and Gi denote intermediate values, and Y0 through Y31 denote output values, the restoring of the M×N block comprises performing the following point inverse-transformation with respect to row-direction input values and column-direction input values of a 16×16 input block, wherein i denotes an integer within a range of between 0 and 31:
{
/stage 0
G16=(12*X1)>>8; G17=(−171*X15)>>8; G18=(109*X9)>>8; G19=(−86*X7)>>8; G20=(62*X5)>>8; G21=(−131*X11)>>8; G22=(152*X13)>>8; G23=(−37*X3)>>8; G24=(253*X3)>>8; G25=(205*X13)>>8; G26=(219*X11)>>8; G27=(248*X5)>>8; G28=(241*X7)>>8; G29=(231*X9)>>8; G30=(189*X15)>>8; G31=(255*X1)>>8;
/Stage 1
F8=(25*X2)>>8; F9=(−162*X14)>>8; F10=(120*X10)>>8; F11=(−74*X6)>>8; F12=(244*X6)>>8; F13=(225*X10)>>8; F14=(197*X14)>>8; F15=(254*X2)>>8;
F16=G16+G17; F17=G16−G17; F18=G19−G18; F19=G19+G18; F20=G20+G21; F21=G20−G21; F22=G23−G22; F23=G23+G22; F24=G24+G25; F25=G24−G25; F26=G27−G26; F27=G27+G26; F28=G28+G29; F29=G28−G29; F30=G31−G30; F31=G31+G30;
/stage 2
E4=(49*X4)>>8; E5=(−142*X12)>>8; E6=(212*X12)>>8; E7=(251*X4)>>8;
E8=F8+F9; E9=F8−F9; E10=F11−F10; E11=F11+F10; E12=F12+F13; E13=F12−F13; E14=F15−F14; E15=F15+F14; E17=(49*F30−251*F17)>>8; E18=(−251*F29−49*F18)>>8; E21=(212*F26−142*F21)>>8; E22=(−142*F25−212*F22)>>8; E25=(212*F25−142*F22)>>8; E26=(142*F26+212*F21)>>8; E29=(49*F29−251*F18)>>8; E30=(251*F30+49*F17)>>8;
/stage 3
D0=(181*(X0))>>8; D1=(181*(X0))>>8; D2=(97*X8)>>8; D3=(236*X8)>>8;
D4=E4+E5; D5=E4−E5; D6=E7−E6; D7=E7+E6; D9=(97*E14−236*E9)>>8; D10=(−236*E13−97*E10)>>8; D13=(97*E13−236*E10)>>8; D14=(236*E14+97*E9)>>8; D16=F16+F19; D19=F16−F19; D20=F23−F20; D23=F23+F20; D24=F24+F27; D27=F24−F27; D28=F31−F28; D31=F31+F28; D17=E17+E18; D18=E17−E18; D21=E22−E21; D22=E22+E21; D25=E25+E26; D26=E25−E26; D29=E30−E29; D30=E30+E29;
/stage 4
C0=D0+D3; C3=D0−D3; C8=E8+E11; C11=E8−E11; C12=E15−E12; C15=E15+E12; C1=D1+D2; C2=D1−D2; C9=D9+D10; C10=D9−D10; C13=D14−D13; C14=D14+D13; C5=(181*(D6−D5))>>8; C6=(181*(D6+D5))>>8; C18=(97*D29−236*D18)>>8; C20=(−236*D27−97*D20)>>8; C26=(−236*D21+97*D26)>>8; C28=(97*D19+236*D28)>>8; C19=(97*D28−236*D19)>>8; C21=(−236*D26−97*D21)>>8; C27=(−236*D20+97*D27)>>8; C29=(97*D18+236*D29)>>8;
/stage 5
B0=C0+D7; B7=C0−D7; B1=C1+C6; B6=C1−C6; B2=C2+C5; B5=C2−C5; B3=C3+D4; B4=C3−D4; B10=(181*(C13−C10))>>8; B13=(181*(C13+C10))>>8; B11=(181*(C12−C11))>>8; B12=(181*(C12+C11))>>8; B16=D16+D23; B23=D16−D23; B24=D31−D24; B31=D31+D24; B17=D17+D22; B22=D17−D22; B25=D30−D25; B30=D30+D25; B18=C18+C21; B21=C18−C21; B26=C29−C26; B29=C29+C26; B19=C19+C20; B20=C19−C20; B27=C28−C27; B28=C28+C27;
/stage 6
A0=B0+C15; A15=B0−C15; A1=B1+C14; A14=B1−C14; A2=B2+B13; A13=B2−B13; A3=B3+B12; A12=B3−B12; A4=B4+B11; A11=B4−B11; A5=B5+B10; A10=B5−B10; A6=B6+C9; A9=B6−C9; A7=B7+C8; A8=B7−C8; A20=(181*(B27−B20))>>8; A27=(181*(B27+B20))>>8; A21=(181*(B26−B21))>>8; A26=(181*(B26+B21))>>8; A22=(181*(B25−B22))>>8; A25=(181*(B25+B22))>>8; A23=(181*(B24−B23))>>8; A24=(181*(B24+B23))>>8;
/stage 7
Y0=A0+B31; Y31=A0−B31; Y1=A1+B30; Y30=A1−B30; Y2=A2+B29; Y29=A2−B29; Y3=A3+B28; Y28=A3−B28; Y4=A4+A27; Y27=A4−A27; Y5=A5+A26; Y26=A5−A26; Y6=A6+A25; Y25=A6−A25; Y7=A7+A24; Y24=A7−A24; Y8=A8+A23; Y23=A8−A23; Y9=A9+A22; Y22=A9−A22; Y10=A10+A21; Y21=A10−A21; Y11=A11+A20; Y20=A11−A20; Y12=A12+B19; Y19=A12−B19; Y13=A13+B18; Y18=A13−B18; Y14=A14+B17; Y17=A14−B17; Y15=A15+B16; Y16=A15−B16;
}

12. The image inverse-transforming method of claim 10, wherein, when each of M and N is equal to 64, each of a and d is equal to 16, X0 through X31 denote input values to be inversely transformed, Ai, Bi, Ci, Di, Ei, Fi, and Zi denote intermediate values, and Y0 through Y63 denote output values, the restoring of the M×N block comprises performing the following point inverse-transformation with respect to the row-direction input values and the column-direction input values of the 16×16 input block, wherein i denotes an integer within a range of between 0 and 63:
{
/stage 0
H32=(25*X1)>>10; H33=0; H34=0; H35=(−369*X15)>>10; H36=(224*X9)>>10; H37=0; H38=0; H39=(−175*X7)>>10; H40=(125*X5)>>10; H41=0; H42=0; H43=(−273*X11)>>10; H44=(321*X13)>>10; H45=0; H46=0; H47=(−75*X3)>>10; H48=(1021*X3)>>10; H49=0; H50=0; H51=(972*X13)>>10; H52=(987*X11)>>10; H53=0; H54=0; H55=(1016*X5)>>10; H56=(1009*X7)>>10; H57=0; H58=0; H59=(999*X9)>>10; H60=(955*X15)>>10; H61=0; H62=0; H63=(1024*X1)>>10;
/stage 1
G16=(50*X2)>>10; G17=0; G18=0; G19=(−345*X14)>>10; G20=(249*X10)>>10; G21=0; G22=0; G23=(−150*X6)>>10; G24=(1013*X6)>>10; G25=0; G26=0; G27=(993*X10)>>10; G28=(964*X14)>>10; G29=0; G30=0; G31=(1023*X2)>>10;
G32=H32+H33; G33=H32−H33; G34=H35−H34; G35=H35+H34; G36=H36+H37; G37=H36−H37; G38=H39−H38; G39=H39+H38; G40=H40+H41; G41=H40−H41; G42=H43−H42; G43=H43+H42; G44=H44+H45; G45=H44−H45; G46=H47−H46; G47=H47+H46; G48=H48+H49; G49=H48−H49; G50=H51−H50; G51=H51+H50; G52=H52+H53; G53=H52−H53; G54=H55−H54; G55=H55+H54; G56=H56+H57; G57=H56−H57; G58=H59−H58; G59=H59+H58; G60=H60+H61; G61=H60−H61; G62=H63−H62; G63=H63+H62;
/stage 2
F8=(100*X4)>>10; F9=0; F10=0; F11=(−297*X12)>>10; F12=(980*X12)>>10; F13=0; F14=0; F15=(1019*X4)>>10;
F16=G16+G17; F17=G16−G17; F18=G19−G18; F19=G19+G18; F20=G20+G21; F21=G20−G21; F22=G23−G22; F23=G23+G22; F24=G24+G25; F25=G24−G25; F26=G27−G26; F27=G27+G26; F28=G28+G29; F29=G28−G29; F30=G31−G30; F31=G31+G30; F33=(100*G62−1019*G33)>>10; F34=(−1019*G61−100*G34)>>10; F37=(792*G58−650*G37)>>10; F38=(−650*G57−792*G38)>>10; F41=(483*G54−903*G41)>>10; F42=(−903*G53−483*G42)>>10; F45=(980*G50−297*G45)>>10; F46=(−297*G49−980*G46)>>10; F49=(980*G49−297*G46)>>10; F50=(297*G50+980*G45)>>10; F53=(483*G53−903*G42)>>10; F54=(903*G54+483*G41)>>10; F57=(792*G57−650*G38)>>10; F58=(650*G58+792*G37)>>10; F61=(100*G61−1019*G34)>>10; F62=(1019*G62+100*G33)>>10;
/stage 3
E4=(200*X8)>>10; E5=0; E6=0; E7=(1004*X8)>>10;
E8=F8+F9; E9=F8−F9; E10=F11−F10; E11=F11+F10; E12=F12+F13; E13=F12−F13; E14=F15−F14; E15=F15+F14; E17=(200*F30−1004*F17)>>10; E18=(−1004*F29−200*F18)>>10; E21=(851*F26−569*F21)>>10; E22=(−569*F25−851*F22)>>10; E25=(851*F25−569*F22)>>10; E26=(569*F26+851*F21)>>10; E29=(200*F29−1004*F18)>>10; E30=(1004*F30+200*F17)>>10; E32=G32+G35; E33=F33+F34; E34=F33−F34; E35=G32−G35; E36=G39−G36; E37=F38−F37; E38=F38+F37; E39=G39+G36; E40=G40+G43; E41=F41+F42; E42=F41−F42; E43=G40−G43; E44=G47−G44; E45=F46−F45; E46=F46+F45; E47=G47+G44; E48=G48+G51; E49=F49+F50; E50=F49−F50; E51=G48−G51; E52=G55−G52; E53=F54−F53; E54=F54+F53; E55=G55+G52; E56=G56+G59; E57=F57+F58; E58=F57−F58; E59=G56−G59; E60=G63−G60; E61=F62−F61; E62=F62+F61; E63=G63+G60;
/stage 4
D0=(724*(X0))>>10; D1=(724*(X0))>>10; D2=0; D3=0;
D4=E4+E5; D5=E4−E5; D6=E7−E6; D7=E7+E6; D9=(392*E14−946*E9)>>10; D10=(−946*E13−392*E10)>>10; D13=(392*E13−946*E10)>>10; D14=(946*E14+392*E9)>>10; D16=F16+F19; D19=F16−F19; D20=F23−F20; D23=F23+F20; D24=F24+F27; D27=F24−F27; D28=F31−F28; D31=F31+F28; D17=E17+E18; D18=E17−E18; D21=E22−E21; D22=E22+E21; D25=E25+E26; D26=E25−E26; D29=E30−E29; D30=E30+E29; D34=(200*E61−1004*E34)>>10; D35=(200*E60−1004*E35)>>10; D36=(−1004*E59−200*E36)>>10; D37=(−1004*E58−200*E37)>>10; D42=(851*E53−569*E42)>>10; D43=(851*E52−569*E43)>>10; D44=(−569*E51−851*E44)>>10; D45=(−569*E50−851*E45)>>10; D50=(851*E50−569*E45)>>10; D51=(851*E51−569*E44)>>10; D52=(569*E52+851*E43)>>10; D53=(569*E53+851*E42)>>10; D58=(200*E58−1004*E37)>>10; D59=(200*E59−1004*E36)>>10; D60=(1004*E60+200*E35)>>10; D61=(1004*E61+200*E34)>>10;
/stage 5
C0=D0+D3; C3=D0−D3; C8=E8+E11; C11=E8−E11; C12=E15−E12; C15=E15+E12; C1=D1+D2; C2=D1−D2; C9=D9+D10; C10=D9−D10; C13=D14−D13; C14=D14+D13; C5=(724*(D6−D5))>>10; C6=(724*(D6+D5))>>10; C18=(392*D29−946*D18)>>10; C20=(−946*D27−392*D20)>>10; C26=(−946*D21+392*D26)>>10; C28=(392*D19+946*D28)>>10; C19=(392*D28−946*D19)>>10; C21=(−946*D26−392*D21)>>10; C27=(−946*D20+392*D27)>>10; C29=(392*D18+946*D29)>>10; C32=E32+E39; C39=E32−E39; C40=E47−E40; C47=E47+E40; C48=E48+E55; C55=E48−E55; C56=E63−E56; C63=E63+E56; C33=E33+E38; C38=E33−E38; C41=E46−E41; C46=E46+E41; C49=E49+E54; C54=E49−E54; C57=E62−E57; C62=E62+E57; C34=D34+D37; C37=D34−D37; C42=D45−D42; C45=D45+D42; C50=D50+D53; C53=D50−D53; C58=D61−D58; C61=D61+D58; C35=D35+D36; C36=D35−D36; C43=D44−D43; C44=D44+D43; C51=D51+D52; C52=D51−D52; C59=D60−D59; C60=D60+D59;
/stage 6
B0=C0+D7; B7=C0−D7; B1=C1+C6; B6=C1−C6; B2=C2+C5; B5=C2−C5; B3=C3+D4; B4=C3−D4; B10=(724*(C13−C10))>>10; B13=(724*(C13+C10))>>10; B11=(724*(C12−C11))>>10; B12=(724*(C12+C11))>>10; B16=D16+D23; B23=D16−D23; B24=D31−D24; B31=D31+D24; B17=D17+D22; B22=D17−D22; B25=D30−D25; B30=D30+D25; B18=C18+C21; B21=C18−C21; B26=C29−C26; B29=C29+C26; B19=C19+C20; B20=C19−C20; B27=C28−C27; B28=C28+C27; B36=(392*C59−946*C36)>>10; B40=(−946*C55−392*C40)>>10; B52=(−946*C43+392*C52)>>10; B56=(392*C39+946*C56)>>10; B37=(392*C58−946*C37)>>10; B41=(−946*C54−392*C41)>>10; B53=(−946*C42+392*C53)>>10; B57=(392*C38+946*C57)>>10; B38=(392*C57−946*C38)>>10; B42=(−946*C53−392*C42)>>10; B54=(−946*C41+392*C54)>>10; B58=(392*C37+946*C58)>>10; B39=(392*C56−946*C39)>>10; B43=(−946*C52−392*C43)>>10; B55=(−946*C40+392*C55)>>10; B59=(392*C36+946*C59)>>10;
/stage 7
A0=B0+C15; A15=B0−C15; A1=B1+C14; A14=B1−C14; A2=B2+B13; A13=B2−B13; A3=B3+B12; A12=B3−B12; A4=B4+B11; A11=B4−B11; A5=B5+B10; A10=B5−B10; A6=B6+C9; A9=B6−C9; A7=B7+C8; A8=B7−C8; A20=(724*(B27−B20))>>10; A27=(724*(B27+B20))>>10; A21=(724*(B26−B21))>>10; A26=(724*(B26+B21))>>10; A22=(724*(B25−B22))>>10; A25=(724*(B25+B22))>>10; A23=(724*(B24−B23))>>10; A24=(724*(B24+B23))>>10; A32=C32+C47; A47=C32−C47; A48=C63−C48; A63=C63+C48; A33=C33+C46; A46=C33−C46; A49=C62−C49; A62=C62+C49; A34=C34+C45; A45=C34−C45; A50=C61−C50; A61=C61+C50; A35=C35+C44; A44=C35−C44; A51=C60−C51; A60=C60+C51; A36=B36+B43; A43=B36−B43; A52=B59−B52; A59=B59+B52; A37=B37+B42; A42=B37−B42; A53=B58−B53; A58=B58+B53; A38=B38+B41; A41=B38−B41; A54=B57−B54; A57=B57+B54; A39=B39+B40; A40=B39−B40; A55=B56−B55; A56=B56+B55;
/stage 8
Z0=A0+B31; Z31=A0−B31; Z1=A1+B30; Z30=A1−B30; Z2=A2+B29; Z29=A2−B29; Z3=A3+B28; Z28=A3−B28; Z4=A4+A27; Z27=A4−A27; Z5=A5+A26; Z26=A5−A26; Z6=A6+A25; Z25=A6−A25; Z7=A7+A24; Z24=A7−A24; Z8=A8+A23; Z23=A8−A23; Z9=A9+A22; Z22=A9−A22; Z10=A10+A21; Z21=A10−A21; Z11=A11+A20; Z20=A11−A20; Z12=A12+B19; Z19=A12−B19; Z13=A13+B18; Z18=A13−B18; Z14=A14+B17; Z17=A14−B17; Z15=A15+B16; Z16=A15−B16; Z40=(724*(A55−A40))>>10; Z55=(724*(A55+A40))>>10; Z41=(724*(A54−A41))>>10; Z54=(724*(A54+A41))>>10; Z42=(724*(A53−A42))>>10; Z53=(724*(A53+A42))>>10; Z43=(724*(A52−A43))>>10; Z52=(724*(A52+A43))>>10; Z44=(724*(A51−A44))>>10; Z51=(724*(A51+A44))>>10; Z45=(724*(A50−A45))>>10; Z50=(724*(A50+A45))>>10; Z46=(724*(A49−A46))>>10; Z49=(724*(A49+A46))>>10; Z47=(724*(A48−A47))>>10; Z48=(724*(A48+A47))>>10;
/stage 9
Y0=Z0+A63; Y63=Z0−A63; Y1=Z1+A62; Y62=Z1−A62; Y2=Z2+A61; Y61=Z2−A61; Y3=Z3+A60; Y60=Z3−A60; Y4=Z4+A59; Y59=Z4−A59; Y5=Z5+A58; Y58=Z5−A58; Y6=Z6+A57; Y57=Z6−A57; Y7=Z7+A56; Y56=Z7−A56; Y8=Z8+Z55; Y55=Z8−Z55; Y9=Z9+Z54; Y54=Z9−Z54; Y10=Z10+Z53; Y53=Z10−Z53; Y11=Z11+Z52; Y52=Z11−Z52; Y12=Z12+Z51; Y51=Z12−Z51; Y13=Z13+Z50; Y50=Z13−Z50; Y14=Z14+Z49; Y49=Z14−Z49; Y15=Z15+Z48; Y48=Z15−Z48; Y16=Z16+Z47; Y47=Z16−Z47; Y17=Z17+Z46; Y46=Z17−Z46; Y18=Z18+Z45; Y45=Z18−Z45; Y19=Z19+Z44; Y44=Z19−Z44; Y20=Z20+Z43; Y43=Z20−Z43; Y21=Z21+Z42; Y42=Z21−Z42; Y22=Z22+Z41; Y41=Z22−Z41; Y23=Z23+Z40; Y40=Z23−Z40; Y24=Z24+A39; Y39=Z24−A39; Y25=Z25+A38; Y38=Z25−A38; Y26=Z26+A37; Y37=Z26−A37; Y27=Z27+A36; Y36=Z27−A36; Y28=Z28+A35; Y35=Z28−A35; Y29=Z29+A34; Y34=Z29−A34; Y30=Z30+A33; Y33=Z30−A33; Y31=Z31+A32; Y32=Z31−A32;
}

13. The image inverse-transforming method of claim 10, wherein, when each of M and N is equal to 32, each of a and d is equal to 16, X0 through X15 denote input values to be inversely transformed, Ai, Bi, Ci, Di, Ei, Fi, and Zi denote intermediate values, and Y0 through Y63 denote output values, the restoring the M×N block comprises performing the following point inverse-transformation with respect to the row-direction input values and the column-direction input values of the 16×16 input block, wherein i denotes an integer within a range of between 0 and 31:
{
/stage 0
D0=X0; E24=X1; E12=X2; F16=−X3; D4=X4; F31=X5; E8=X6; E26=−X7; D2=X8; E21=X9; E15=X10; F29=X11; E5=X12; F18=−X13; D13=X14; D22=X15;
/stage 1
E16=(251*F16)>>8; E17=(−49*F16)>>8; E18=(212*F18)>>8; E19=(−142*F18)>>8; E28=(142*F29)>>8; E29=(212*F29)>>8; E30=(49*F31)>>8; E31=(251*F31)>>8;
/stage 2
D5=(181*(E5))>>8; D7=(181*(E5))>>8; D8=(97*E8)>>8; D9=(−236*E8)>>8; D11=(181*(−E12))>>8; D12=(181*(E12))>>8; D14=(236*E15)>>8; D15=(97*E15)>>8; D16=E16+E18; C18=E16−E18; C17=E17+E19; D19=E17−E19; D20=(−97*E21)>>8; D21=(236*E21)>>8; D23=(181*(−E24))>>8; D24=(181*(E24))>>8; D26=(236*E26)>>8; D27=(97*E26)>>8; D28=−E28+E30; C30=E28+E30; C29=−E29+E31; D31=E29+E31;
/stage 3
C0=(181*D0)>>8; C1=(181*D0)>>8; C2=(97*D2)>>8; C3=(236*D2)>>8; C4=D4+D5; C5=D4−D5; C6=D7; C7=D7; C8=D8+D14; C14=D8−D14; C9=D9+D15; C15=D9−D15; C10=D11; C11=−D11; C12=D12+D13; C13=D12−D13; C16=(181*(D16−D19))>>8; C19=(181*(D16+D19))>>8; C20=D20+D26; C26=D20−D26; C21=D21+D27; C27=D21−D27; C22=D22+D23; C23=D22−D23; C24=D24; C25=D24; C28=(181*(D28−D31))>>8; C31=(181*(D28+D31))>>8;
/stage 4
B0=C0+C3; B3=C0−C3; B1=C1+C2; B2=C1−C2; B4=(49*C4−251*C7)>>8; B7=(251*C4+49*C7)>>8; B5=(142*C5−212*C6)>>8; B6=(212*C5+142*C6)>>8; B8=C8+C11; B11=C8−C11; B9=C9+C10; B10=C9−C10; B12=C12+C15; B15=C12−C15; B13=C13+C14; B14=C13−C14; B16=C16+C28; B28=C16−C28; B17=C17+C29; B29=C17−C29; B18=C18+C30; B30=C18−C30; B19=C19+C31; B31=C19−C31; B20=C20+C23; B23=C20−C23; B21=C21+C22; B22=C21−C22; B24=C24+C27; B27=C24−C27; B25=C25+C26; B26=C25−C26;
/stage 5
A0=B0+B7; A7=B0−B7; A1=B1+B6; A6=B1−B6; A2=B2+B5; A5=B2−B5; A3=B3+B4; A4=B3−B4; A8=(197*B8−162*B15)>>8; A15=(162*B8+197*B15)>>8; A9=(120*B9+225*B14)>>8; A14=(−225*B9+120*B14)>>8; A10=(244*B10−74*B13)>>8; A13=(74*B10+244*B13)>>8; A11=(25*B11+254*B12)>>8; A12=(−254*B11+25*B12)>>8; A16=B16+B23; A23=B16−B23; A17=B17+B22; A22=B17−B22; A18=B18+B21; A21=B18−B21; A19=B19+B20; A20=B19−B20; A24=B24+B31; A31=B24−B31; A25=B25+B30; A30=B25−B30; A26=B26+B29; A29=B26−B29; A27=B27+B28; A28=B27−B28;
/stage 6
Z0=A0+A15; Z1=A1+A14; Z2=A2+A13; Z3=A3+A12; Z4=A4+A11; Z5=A5+A10; Z6=A6+A9; Z7=A7+A8; Z8=A7−A8; Z9=A6−A9; Z10=A5−A10; Z11=A4−A11; Z12=A3−A12; Z13=A2−A13; Z14=A1−A14; Z15=A0−A15; Z16=(171*A16+189*A31)>>8; Z31=(−189*A16+171*A31)>>8; Z17=(205*A17−152*A30)>>8; Z30=(152*A17+205*A30)>>8; Z18=(131*A18+219*A29)>>8; Z29=(−219*A18+131*A29)>>8; Z19=(231*A19−109*A28)>>8; Z28=(109*A19+231*A28)>>8; Z20=(86*A20+241*A27)>>8; Z27=(−241*A20+86*A27)>>8; Z21=(248*A21−62*A26)>>8; Z26=(62*A21+248*A26)>>8; Z22=(37*A22+253*A25)>>8; Z25=(−253*A22+37*A25)>>8; Z23=(255*A23−12*A24)>>8; Z24=(12*A23+255*A24)>>8
/stage 7
Y0=Z0+Z31; Y31=Z0−Z31; Y1=Z1+Z30; Y30=Z1−Z30; Y2=Z2+Z29; Y29=Z2−Z29; Y3=Z3+Z28; Y28=Z3−Z28; Y4=Z4+Z27; Y27=Z4−Z27; Y5=Z5+Z26; Y26=Z5−Z26; Y6=Z6+Z25; Y25=Z6−Z25; Y7=Z7+Z24; Y24=Z7−Z24; Y8=Z8+Z23; Y23=Z8−Z23; Y9=Z9+Z22; Y22=Z9−Z22; Y10=Z10+Z21; Y21=Z10−Z21; Y11=Z11+Z20; Y20=Z11−Z20; Y12=Z12+Z19; Y19=Z12−Z19; Y13=Z13+Z18; Y18=Z13−Z18; Y14=Z14+Z17; Y17=Z14−Z17; Y15=Z15+Z16; Y16=Z15−Z16;
}

14. The image inverse-transforming method of claim 10, wherein, when each of M and N is equal to 32, each of a and d is equal to 16, X0 through X31 denote input values to be inversely transformed, Ai, Bi, Ci, Di, Ei, Fi, and Zi denote intermediate values, and Y0 through Y32 denote output values, the restoring of the M×N block is performed comprises performing the following point inverse-transformation with respect to the row-direction input values and the column-direction input values of the 16×16 input block, wherein i denotes an integer within a range of between 0 and 31:
{
/stage 0
D0=X0; E24=X1; E12=X2; F16=−X3; D4=X4; F31=X5; E8=X6; E26=−X7; D2=X8; E21=X9; E15=X10; F29=X11; E5=X12; F18=−X13; D13=X14; D22=X15;
/stage 1
E17=−(48*F16>>8); E16=F16+(50*E17>>8); E19=−(118*F18>>8); E18=F18+(171*E19>>8);
E29=F29; E28=(171*E29>>8); E31=F31; E30=(50*E31>>8);
/stage 2
D7=(E5>>1); D5=E5−D7;
D9=−E8; D8=−(106*D9>>8);
D12=E12; D11=−D12;
D15=(90*E15>>8); D14=E15−(106*D15>>8);
D16=E16+E18; C18=E16−E18; C17=E17+E19; D19=E17−E19;
D21=E21; D20=−(106*D21>>8); D24=E24; D23=−D24; D27=(90*E26>>8); D26=E26−(106*D27>>8); D28=−E28+E30; C30=E28+E30; C29=−E29+E31; D31=E29+E31;
/stage 3
C1=D0>>1; C0=D0−C1;
C3=D2; C2=(106*C3>>8);
C4=D4+D5; C5=D4−D5; C6=D7; C7=D7;
C8=D8+D14; C14=D8−D14; C9=D9+D15; C15=D9−D15; C10=D11; C11=−D11; C12=D12+D13; C13=D12−D13;
D16=D16−(106*D19>>8); C19=D19+(181*D16>>8); C16=D16−(106*C19>>8); C20=D20+D26; C26=D20−D26; C21=D21+D27; C27=D21−D27; C22=D22+D23; C23=D22−D23; C24=D24; C25=D24; D28=D28−(106*D31>>8); C31=D31+(181*D28>>8); C28=D28−(106*C31>>8);
/stage 4
B0=C0+C3; B3=C0−C3; B1=C1+C2; B2=C1−C2;
C4=C4−(210*C7>>8); B7=C7+(251*C4>>8); B4=C4−(210*B7>>8); C5=C5−(136*C6>>8); B6=C6+(212*C5>>8); B5=C5−(136*B6>>8);
B8=C8+C11; B11=C8−C11; B9=C9+C10; B10=C9−C10;
B12=C12+C15; B15=C12−C15; B13=C13+C14; B14=C13−C14;
B16=C16+C28; B28=C16−C28; B17=C17+C29; B29=C17−C29; B18=C18+C30; B30=C18−C30; B19=C19+C31; B31=C19−C31;
B20=C20+C23; B23=C20−C23; B21=C21+C22; B22=C21−C22;
B24=C24+C27; B27=C24−C27; B25=C25+C26; B26=C25−C26;
/stage 5
A0=B0+B7; A7=B0−B7; A1=B1+B6; A6=B1−B6; A2=B2+B5; A5=B2−B5; A3=B3+B4; A4=B3−B4;
B8=B8−(91*B15>>8); A15=B15+(162*B8>>8); A8=B8−(91*A15>>8); B9=B9+(153*B14>>8); A14=B14−(225*B9>>8); A9=B9+(153*A14>>8); B10=B10−(37*B13>>8); A13=B13+(74*B10>>8); A10=B10−(37*A13>>8); B11=B11+(232*B12>>8); A12=B12−(254*B11>>8); A11=B11+(232*A12>>8); A16=B16+B23; A23=B16−B23; A17=B17+B22; A22=B17−B22; A18=B18+B21; A21=B18−B21; A19=B19+B20; A20=B19−B20;
A24=B24+B31; A31=B24−B31; A25=B25+B30; A30=B25−B30; A26=B26+B29; A29=B26−B29; A27=B27+B28; A28=B27−B28;
/stage 6
Z0=A0+A15; Z1=A1+A14; Z2=A2+A13; Z3=A3+A12; Z4=A4+A11; Z5=A5+A10; Z6=A6+A9; Z7=A7+A8; Z8=A7−A8; Z9=A6−A9; Z10=A5−A10; Z11=A4−A11; Z12=A3−A12; Z13=A2−A13; Z14=A1−A14; Z15=A0−A15;
A16=A16+(113*A31>>8); Z31=A31−(189*A16>>8); Z16=A16+(113*Z31>>8); A17=A17−(84*A30>>8); Z30=A30+(152*A17>>8); Z17=A17−(84*Z30>>8); A18=A18+(145*A29>>8); Z29=A29−(219*A18>>8); Z18=A18+(145*Z29>>8); A19=A19−(57*A28>>8); Z28=A28+(109*A19>>8); Z19=A19−(57*Z28>>8); A20=A20+(180*A27>>8); Z27=A27−(241*A20>>8); Z20=A20+(180*Z27>>8); A21=A21−(31*A26>>8); Z26=A26+(62*A21>>8); Z21=A21−(31*Z26>>8); A22=A22+(220*A25>>8); Z25=A25−(253*A22>>8); Z22=A22+(220*Z25>>8); A23=A23−(6*A24>>8); Z24=A24+(12*A23>>8); Z23=A23−(6*Z24>>8);
/stage 7
Y0=Z0+Z31; Y31=Z0−Z31; Y1=Z1+Z30; Y30=Z1−Z30; Y2=Z2+Z29; Y29=Z2−Z29; Y3=Z3+Z28; Y28=Z3−Z28; Y4=Z4+Z27; Y27=Z4−Z27; Y5=Z5+Z26; Y26=Z5−Z26; Y6=Z6+Z25; Y25=Z6−Z25; Y7=Z7+Z24; Y24=Z7−Z24; Y8=Z8+Z23; Y23=Z8−Z23; Y9=Z9+Z22; Y22=Z9−Z22; Y10=Z10+Z21; Y21=Z10−Z21; Y11=Z11+Z20; Y20=Z11−Z20; Y12=Z12+Z19; Y19=Z12−Z19; Y13=Z13+Z18; Y18=Z13−Z18; Y14=Z14+Z17; Y17=Z14−Z17; Y15=Z15+Z16; Y16=Z15−Z16;
}

15. An image inverse-transforming apparatus comprising:
a truncated inverse-transform matrix acquisition unit which acquires a truncated inverse-transform matrix by selecting elements to be used for performing an inverse transformation with respect to transformation coefficients which correspond to a predetermined frequency band from among elements of an M×N inverse-transform matrix to be used for performing a frequency inverse-transformation with respect to a transformed block which relates to an M×N block, wherein M and N are positive integers; and
an inverse-transformation unit which restores the M×N block by performing the frequency inverse-transformation by applying the truncated inverse-transform matrix to the transformed block which corresponds to the predetermined frequency band.

16. The image inverse-transforming apparatus of claim 15, wherein the truncated inverse-transform matrix acquisition unit selects the elements to be used for performing the inverse transformation by selecting A rows from among rows included in the M×N inverse-transform matrix in order to form an A×N vertical inverse-transform matrix and by selecting D columns from among columns included in the M×N inverse-transform matrix in order to form an M×D horizontal inverse-transform matrix, wherein A denotes a positive integer which is less than M and D denotes a positive integer which is less than N; and
wherein the inverse-transformation unit restores the M×N block by applying each of the vertical inverse-transform matrix and the horizontal inverse-transform matrix to the transformed block.

17. The image transformer apparatus of claim 16, wherein when the predetermined frequency band corresponds to a lowest frequency area which relates to the M×N inverse-transform matrix, the matrix generator selects the A topmost rows from among the rows included in the M×N inverse-transform matrix in order to form the A×N vertical inverse-transform matrix, and the matrix generator selects the D leftmost columns from among the columns included in the M×N inverse-transform matrix in order to form the M×D horizontal inverse-transform matrix.

18. An image transformer apparatus, comprising:
a frequency selector which selects a frequency area which relates to an M×N input block, wherein M and N are positive integers;
a matrix generator which selects elements to be used for a generation of transformation coefficients which correspond to the selected frequency area from among elements of an M×N transform matrix, and uses the selected elements to generate a transform matrix; and
a frequency transformer which generates the transformation coefficients by performing a frequency transformation by applying the generated transform matrix to the M×N input block.

19. The image transformer apparatus of claim 18, wherein the frequency selector selects a frequency area which relates to the M×N input block by selecting an A×D sub-block from within the M×N input block, wherein A denotes a positive integer which is less than M and D denotes a positive integer which is less than N;
wherein the matrix generator selects the elements to be used for the generation of the transform matrix by selecting A rows from among rows included in the M×N transform matrix in order to form an A×N vertical transform matrix and by selecting D columns from among columns included in the M×N transform matrix in order to form an M×D horizontal transform matrix; and
wherein the frequency transformer generates a transform matrix by applying each of the vertical transform matrix and the horizontal transform matrix to the M×N input block.

20. The image transformer apparatus of claim 19, wherein when the frequency selector selects a lowest frequency area which relates to the M×N input block, the matrix generator selects the A topmost rows from among the rows included in the M×N transform matrix in order to form the A×N vertical transform matrix, and the matrix generator selects the D leftmost columns from among the columns included in the M×N transform matrix in order to form the M×D horizontal transform matrix.
